(19) United States
(12) Patent Application Publication
(10) Pub. No.: US 2021/0133641 A1
(43) Pub. Date: May 6, 2021

(54) MULTI-PASSENGER AND MULTIATTRIBUTE TRAVEL BOOKING PLATFORM

(71) Applicant: Amgine Technologies (US), Inc., Dover, DE (US)

(72) Inventors: L. James Valverde, JR., Washington, DC (US); Jonathan David Miller, Toronto (CA); Harold Roy Miller, Toronto (CA)

(21) Appl. No.: 17/118,259

(22) Filed: Dec. 10, 2020

Related U.S. Application Data
(63) Continuation-in-part of application No. 15/178,064, filed on Jun. 9, 2016, now abandoned.
Application No. 15/178,064 is a continuation-in-part of application No. 14/750,841, filed on Jun. 25, 2015.
(60) Provisional application No. 62/174,387, filed on Jun. 11, 2015.

(51) Int. Cl. G06Q 10/02; G06Q 50/14; G06Q 30/06; G06F 16/9032

(52) U.S. Cl. CPC G06Q 10/025; G06F 16/90332; G06Q 30/0621; G06Q 50/14

(57) ABSTRACT

Systems and methods for facilitating multi-passenger and multiattribute travel reservations are presented. The system has a database, a scheduler, a parser, and a processor. The database stores a travel lexicon having attribute names and a travel taxonomy having look-up tables. The scheduler instantiates travel attributes in terms of the travel lexicon to generate instantiated user preferences, indexes the instantiated user preferences, and searches for feasible travel itineraries. The parser parses user preferences to derive a vector function having attribute values and ascertains relevant attribute sets for the user preferences. The processor receives the user preferences from a user device, ranks and weights the attribute values based on encoded preference information derived from the user preferences, associates values to the feasible travel itineraries, and transmits the feasible itineraries to the user device to present a multiattributed travel itinerary to visualize itinerary information associated with each of the travel attributes.

### CROSS-REFERENCE TO RELATED APPLICATIONS

The present utility patent application is related to and a continuation-in-part of U.S. patent application Ser. No. 14/750,841 filed Jun. 25, 2015, and U.S. patent application Ser. No. 15/178,064 filed Jun. 9, 2016, which claims the priority benefit under 35 U.S.C. 119(e) of U.S. provisional application No. 62/174,387, filed on Jun. 11, 2015, and titled “Multi-Passenger Travel Booking Platform.” The disclosure of these related non-provisional and provisional applications is incorporated herein by reference for all purposes to the extent that such subject matter is not inconsistent herewith or limiting hereof.

### TECHNICAL FIELD

The present disclosure relates to data processing and, more particularly, to facilitating travel reservations using a multi-passenger travel booking platform.

### BACKGROUND

Consumers of travel booking services or their representatives, such as travel agents, enjoy a plurality of options. The travel market is replete with numerous sources providing travel-related information and advice on everything from destinations to hotels, related points of interest, and pricing data for a vast array of goods and services. While consumers can derive much utility from this choice environment enabled by travel management companies, online travel agencies (OTAs) and travel websites, a choice task of the consumer is often encumbered by information abundance and by legacy technology platforms that almost invariably complicate the consumer choice problem.

These choice-related challenges can take many forms, which include a large number of viable itinerary options to sort through, evaluate, and ultimately choose from; disparate and non-homogenous information sources, all of which possess varying degrees of quality, usefulness, and reliability; and the need to consider complex value trade-offs among key choice attributes and objectives (e.g., price vs. suitability of a selected flight for the consumer), together with the existence of often conflicting objectives (e.g., a desire for luxury, constrained by willingness-to-pay). Existing travel booking technologies are incapable of efficiently handling complex itinerary requests, involving multiple, perhaps geographically-distributed, travelers. For example, there are systems for single-passenger itineraries; there are systems for multi-passengers using a single itinerary; but there aren't systems that reconcile the preferences of multiple passengers using integrated itineraries, such as a group of business travelers that need to coordinate their itineraries is various ways; and there aren't systems that reconcile the preferences of individual passengers that are weighing their preferences across multiple feasible and integrated itineraries, such as a complex business trip or a family trip involving many different destinations.

It should be noted that the task of finding a path between an ‘Origin’ and a ‘Destination’ and the associated schedule for traversing that path in such a way that certain criteria are optimized (maximized or minimized) is a computation-intensive task. This routing/scheduling/optimization task becomes considerably more complex when one or more of the following itinerary features are present:
Itineraries comprising multiple passengers (for example, two or more);
In multi-passenger itineraries, coordination and scheduling of non-collocated (i.e., geographically distributed) passengers (e.g., scheduling travel for annual Board of Directors meetings, family reunions, and the like);
Multiple leg-segments and/or destinations;
Passenger-specific arrival and/or departure time preferences or constraints;
Other constraints:
   Budget constraints (global or passenger-specific);
   Desired performance-, service-, or routing-related attributes or constraints (e.g., early boarding, premium economy seating, desired hub connection, etc.);
   Desired ancillary content.

Systematically handling travel-related queries that are characterized by one or more of these attributes requires sophisticated routing, scheduling, and optimization capabilities. Extant travel booking platforms (such as Expedia®, Travelocity®, Sabre®, and so forth) are largely incapable of handling these types of queries.

To overcome the choice-related challenges, consumers typically utilize a vast array of short-cuts and heuristics, all of which enable the consumer to sift through and evaluate numerous choice options, in ways that lead, ultimately, to choices that satisfy the consumer. However, existing travel booking platforms do not always confront these challenges to consumer satisfaction. The existing systems are unable to reconcile a multiattribute problem, where there are a number of feasible itineraries and a need for decision-makers to decide which ones they want to adopt. In other words, delivering travel booking capabilities to the consumer needs to be redesigned to improve the consumer experience during travel reservations and to overcome the multi-passenger and multiattribute problems.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a system for facilitating multi-passenger and multiattribute travel reservations is provided. The system may comprise a database in communication with a processor, a scheduler in communication with the processor, a parser in communication with the processor, and the processor. The database may have stored thereon a travel lexicon having attribute names and related values for passengers, flights, hotels, origins, and destinations; and a travel taxonomy comprising look-up tables having logical relations and predicates. The scheduler may be operable to instantiate, for each of a plurality of attributes of a travel request, at least one attribute of the plurality of attributes in terms of the travel lexicon that are relevant to user preferences, thereby generating a plurality of instantiated user preferences; index the plurality of instantiated user preferences, thereby generating an attribute index comprising a plurality of indexed travel attributes defined in terms of the travel lexicon; and search for feasible travel itineraries based on the plurality of indexed travel attributes, the feasible travel itineraries determined based on at least two weighted attributes associated with each of the plurality of attributes. The parser may be operable to parse the user preferences to derive a vector function comprising at least two attribute values related to the plurality of indexed travel attributes for each of the plurality of attributes; and ascertain a plurality of relevant attribute sets for the user preferences, each of the plurality of relevant attribute sets being associated with one of the plurality of attributes, each of the plurality of relevant attribute sets comprising the at least two attribute values for the user preferences. The processor may be operable to receive the user preferences from the consumer via a user device, the user preferences being associated with the plurality of attributes; rank the at least two attribute values related to the relevant attribute set based on encoded preference information derived from the user preferences, thereby generating a ranking that represents a relative importance of each attribute value related to the relevant attribute set; assign weights to each of the at least two attribute values based on the ranking to create at least two weighted attributes for the relevant attribute set; associate a value to each of the feasible travel itineraries based on the at least two weighted attributes and a value score corresponding to a performance of the feasible travel itinerary under each of the at least two travel attributes, thereby generating rank-order preference data for the user preferences; and transmit the feasible travel itineraries to the user device to present, to the consumer via the user device, at least one multiattributed travel itinerary to visualize itinerary information associated with each of the plurality of attributes, wherein at least a portion of the itinerary information is variable among the plurality of attributes.

According to some example embodiments of the disclosure, the user preferences may be determined from at least one of a travel-related query, the database, the user device, or a server.

According to one example embodiments of the disclosure, the system may further comprise a human-computer interface to receive the user preferences.

According to some example embodiments of the disclosure, the database may further have stored thereon one or more of the following: the preexisting user preferences of the user and the preexisting user preferences of one or more further users.

According to one example embodiment of the disclosure, the travel preferences may be provided via at least one of the following: a natural language oral exchange, a natural language typed text, and a selection of preexisting options.

According to some example embodiments of the disclosure, the processor may be further configured to receive a revision request associated with at least one of the plurality of attributes, the revision request being associated with an alteration of at least one of the attribute values or an addition of a further attribute value; and based on the revision request, instantiate a further attribute with an altered derived attribute value or the further attribute value; and wherein the scheduler may be further configured to search, based on the instantiating, for further feasible travel itineraries based on the further attribute.

According to one example embodiment of the disclosure, presenting the multiattributed travel itinerary may further comprise: identifying, based on the weights, one or more attributes having highest weights; and visually marking the one or more attributes having the highest weights on the multiattributed travel itinerary.

According to some example embodiments of the disclosure, presenting the multiattributed travel itinerary may further include providing visual cues on the multiattributed travel itinerary, the visual cues being associated with the one or more attributes having the highest weights.

According to one example embodiment of the disclosure, the processor may be further configured to select the at least one multiattributed travel itinerary from the feasible travel itineraries, wherein the at least one multiattributed travel itinerary is associated with the one or more attributes having the highest weights for at least one of the plurality of attributes.

According to some example embodiments of the disclosure, presenting the multiattributed travel itinerary may include visualizing segments of the at least one multiattributed travel itinerary.

According to one example embodiment of the disclosure, the at least one multiattributed travel itinerary for the plurality of attributes may be presented as a matrix, the matrix comprising a plurality of columns and a plurality of rows, each of the plurality of columns in the matrix associated with one of the plurality of attributes, and each of the plurality of rows in the matrix is associated with at least one attribute. According to some example embodiments, each of the plurality of rows may be further associated with at least one of the following: hotel information, rental car information, and flight information.

According to some example embodiments of the disclosure, the user preferences may be configured to be graphically displayed to a consumer via a vector diagram depicting categories of the user preferences, and the consumer sets weights for each of the categories by moving corners of a polygon shown on the vector diagram.

According to some example embodiments of the disclosure, a method for facilitating multi-passenger and multiattribute travel reservations by a computer processor is provided. The processor may be in communication with a database having stored thereon (a) a travel lexicon having attribute names and related attribute values for passengers, flights, hotels, origins, and destinations, and (b) a travel taxonomy comprising look-up tables having logical relations and predicates. The method may comprise receiving user preferences from the consumer via a user device, the user preferences being associated with a plurality of attributes. The method may continue with instantiating, for each of a plurality of attributes of a travel request, at least one travel attribute in terms of the travel lexicon that is relevant to the user preferences, thereby generating a plurality of instantiated user preferences. The method may continue with indexing the plurality of instantiated user preferences, thereby generating an attribute index comprising a plurality of indexed travel attributes defined in terms of the travel lexicon. Furthermore, the method may continue with parsing the user preferences to derive a vector function comprising at least two attribute values related to the plurality of indexed travel attributes comprised in the attribute index. The method may continue with ascertaining a plurality of relevant attribute sets for the user preferences, each of the plurality of relevant attribute sets being associated with one of the plurality of attributes, wherein the plurality of relevant attribute sets comprising at least two attribute values for the user preferences. Further, the method may continue with receiving user preferences for the user from a consumer. The method may continue with ranking the at least two attribute values related to the relevant attribute set based on encoded preference information derived from the user preferences, thereby generating a ranking that represents a relative importance of each attribute in the relevant attribute set. Furthermore, the method may include assigning weights to each of the at least two attribute values based on the ranking to create at least two weighted attributes for the relevant attribute set. The method may continue with searching, for each of the plurality of attributes, for feasible travel itineraries based on the plurality of indexed travel attributes, the feasible travel itineraries determined based on the at least two weighted attributes associated with each of the plurality of attributes. Further, the method may include associating a value to each of the feasible travel itineraries based on the at least two weighted attributes and a value score corresponding to a performance of the feasible itinerary under each of the at least two travel attributes, thereby generating rank-order preference data the user preferences. The method may continue with transmitting the feasible travel itineraries to the user device to present, to the consumer via the user device, at least one multiattributed travel itinerary, the multiattributed travel itinerary comprising separate itinerary information for each of the plurality of attributes.

According to some example embodiments of the disclosure, the user preferences may be determined from at least one of a travel-related query, the database, the user device, or a server.

According to one example embodiment of the disclosure, the method may further comprise providing a human-computer interface to receive the user preferences.

According to some example embodiments of the disclosure, the user preferences may be provided via at least one of the following: a natural language oral exchange, a natural language typed text, and a selection of preexisting options.

According to one example embodiment of the disclosure, the database may have further stored thereon one or more of the following: the preexisting user preferences of the user and the preexisting user preferences of one or more further users.

According to some example embodiments of the disclosure, the method may further comprise: receiving, by the processor, a revision request, the revision request being associated with at least one of the plurality of attributes, the revision request being associated with an alteration of at least one of the attribute values or an addition of a further attribute value; based on the revision request, instantiating, by the processor, a further attribute with an altered derived attribute value or the further attribute value; and based on the instantiating, searching, by the scheduler, for further feasible travel itineraries based on the further attribute.

According to one example embodiment of the disclosure, the presenting the multiattributed travel itinerary may further comprise: identifying, based on the weights, one or more attributes having highest weights; and visually marking the one or more attributes having the highest weights on the multiattributed travel itinerary.

According to some example embodiments of the disclosure, presenting the multiattributed travel itinerary may further include providing visual cues on the multiattributed travel itinerary, the visual cues being associated with the one or more attributes having the highest weights. According to one example embodiment of the disclosure, the presenting may further include visualizing segments of the at least one multiattributed travel itinerary.

According to some example embodiments of the disclosure, the at least one multiattributed travel itinerary for each of the plurality of attributes may be presented as a matrix, the matrix comprising a plurality of columns and a plurality of rows, each of the plurality of columns in the matrix associated with one of the plurality of attributes, and each of the plurality of rows in the matrix associated with at least one attribute.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for facilitating travel reservations can be implemented.

FIG. 2 is a block diagram showing various modules of the system for facilitating travel reservations.

FIGS. 3A and 3B are process flow diagrams showing a method for facilitating travel reservations.

FIG. 4 illustrates dependency of utility of a travel itinerary on a number of stops.

FIG. 5 is a graphical representation of travel itineraries found by a scheduler.

FIG. 6 illustrates a matrix for representation of multi-passenger travel itineraries.

FIGS. 7-17 show user interfaces associated with presenting multi-passenger travel itineraries in a system for facilitating travel reservations.

FIGS. 18-23 show user interfaces related to a user profile associated with a system for facilitating travel reservations.

FIG. 24 shows results of a search performed by a scheduler.

FIG. 25 illustrates a representation of numeric results of a search performed by a scheduler.

FIG. 26 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The disclosure relates to a multi-passenger and multiattribute travel booking platform that can enable individual consumers to identify itinerary options that match preferences of the consumers while reducing search efforts. The platform addresses, among others, the technical problem that user queries may be about anything, and not constrained within the travel domain. A related problem is on the search side: the many possible attributes of this open domain search need to be compressed to facilitate an efficient retrieval of relevant content within the target travel domain.

Additionally, the platform can simplify a choice task for a consumer and increase the quality of purchase decisions made via the platform. When a consumer needs to book a trip, for example, a travel agent booking a business trip for several passengers, the consumer may take a number of factors into consideration, for example, even though a destination city of the trip may be the same, the origin cities of the passengers may differ. Additionally, each of the passengers may have their own preferences with respect to specific details of the trip, such as a hotel rating, minimal flight connecting time, a car model to be rented in the destination city, and so forth, or a single passenger may be entertaining many such preferences simultaneously. To facilitate the making of travel reservations, a travel itinerary selected by the multi-passenger and multiattribute travel booking platform in response to a travel-related query of the consumer may be presented to the consumer so as to visualize multi-person (multi-passenger) or multiattribute itineraries, thereby efficiently and effectively conveying all relevant information pertaining to flights, hotels, and rental cars, together with any pertinent ancillary content.

More specifically, upon receiving a travel related query associated with several passengers or multiple attributes (multiattributes), the multi-passenger and multiattribute travel booking platform may determine attribute sets for each of the passengers. Further, for each of the passengers, the multi-passenger and multiattribute travel booking platform may instantiate attributes of the attribute sets with the derived attribute values. The attributes may have differing levels of importance for the consumer. Therefore, the platform may prioritize and rank the attributes based on consumer preferences. Based on the ranking, each of the attributes may be assigned a weight depending on an importance of this attribute for the consumer. Based on the attribute sets and the attribute values, the multi-passenger and multiattribute travel booking platform may search for feasible travel itineraries for each of the preference sets. Upon the search, the multi-passenger and multiattribute travel booking platform may present a multiattribute travel itinerary for each of the passengers or preference sets. The weighted attributes may be used to score each of the feasible travel itineraries. The travel itineraries having the highest scores may be presented to the consumer in response to the travel related query.

While depicting and visualizing multi-passenger and multiattribute itineraries for the consumer, the multi-passenger and multiattribute travel booking platform may utilize a graphical and visual language to convey defining elements of multiattribute itineraries. The defining elements may include, for example, flight-specific information, such as a time of a flight or number of connections, hotel-specific information, such as a hotel rating, or any other elements related to the travel. The defining elements of the multiattribute travel itinerary may be presented to the consumer in the simplest and most efficient manner possible. The multi-passenger and multiattribute travel booking platform may use a column-centric architecture designed to provide an at-a-glance view of all information pertinent to a multi-passenger itinerary, including passenger-specific flight-, hotel-, and rental car-related information. More specifically, the multiattribute travel itineraries may be presented as a table consisting of s columns, with each denoting labels (such as names) of the passenger or preference sets parsed based on in the travel query, and r rows that may partition each column into regions that convey preference-specific information, such as information pertaining to flights, hotels, car rental reservations, and so forth.

While determining multiattributes relevant to the travel related query, the platform may create a linkage between (i) natural language instantiation of itinerary-relevant attributes via parsing the travel related query; and (ii) consumer-specified preference information concerning relevant travel goods and services (e.g., airlines and hotels), which, for example, can be ascertained from profiles associated with the accounts. The multi-passenger and multiattribute travel booking platform can be based on the following principles.

Firstly, the platform is both intention- and preference-driven. The platform is developed at the foundations of travel planning actions and travel-related consumption. The platform can therefore be capable of “understanding” travel-related requests in terms of the determinate goals and objectives of consumers, as well as include the ability to properly handle the logistics of travel. To the extent that it is possible for the platform to either “know” or infer the travel-related preferences of the consumer, the preferences may factor into how travel requests are ultimately serviced within the platform.

Secondly, a human-computer interface of the platform can enable specifying travel-related goals and objectives. For this purpose, the platform may use parsing of natural language of the travel related queries. Accordingly, the platform can enable the consumer to articulate/specify intent via natural language queries, with the built-in intelligence to understand a robust travel lexicon.

Thirdly, the platform can be capable of supporting the complex logistics and scheduling of multi-passenger or multi-leg or multi-city itineraries. The platform may incorporate complex scheduling capabilities, enabling groups of travelers (e.g., business colleagues or families) to effectively plan and book travel.

Fourthly, the platform can possess true end-to-end integration, including fulfillment. A characteristic feature of many travel applications and web sites is the ability to move from search/research to booking/purchase within the application. The platform may have en suite capabilities that never require the consumer to exit the travel application environment prior to making a purchase decision, thereby providing the consumer with an immersive “all-in-one” experience from making a travel related query to purchasing tickets for travel.

Furthermore, interactivity and control can be built into the platform, and the consumer may be able to personalize aspects of the interactivity. The consumer can be able to define aspects of how the consumer interacts with and consumes travel content. The platform may therefore be capable of receiving requests of the consumer (in fact, capable of “listening” to the consumer), with the goal of finding satisfying solutions to articulated/stated goals and objectives, consistent with underlying preferences and consumer willingness-to-pay. Moreover, the platform may enable the consumer to amend/revise plans during searching for a requisite purchase decision.

Moreover, the platform may possess both stage and state awareness. More specifically, the platform may be operable to determine where the consumer is in the path-to-purchase. With this awareness, the platform may come to determining of information requirements and needs of the consumer.

Additionally, the platform may possess a purpose-built choice architecture that may provide the consumer with decision aiding capabilities. The goal is to provide the consumer with the most efficient route to a requisite or satisfying purchase decision.

Furthermore, the platform may incorporate journey management capabilities to enable the consumer to change elements of a travel itinerary. It is often the case that changes must be made to one or more aspects of a purchased travel itinerary—driven, for example, by endogenous reasons (e.g., the change of travel plans of the consumer) or by exogenous factors (e.g., extreme weather).

Additionally, the platform may be consumer-centric in both the design of the platform and how the platform acts in the marketplace, thereby maximizing the efficiency of purchase and the travel-buying experience. The goal of the platform is to deliver maximal utility to the consumer and the business; the platform is therefore “utility-centric,” as opposed to merely profit-centric.

Many of the core design elements and principles of the platform outlined above relate directly to how feasible travel requests can be identified and presented for consideration to the consumer. In this regard, the platform may tend to explore the manner in which choice is manifested within the platform. The more travel itinerary options that are presented to the consumer, the greater the chance that the consumer finds a travel itinerary that aligns with preferences of the consumer. Therefore, there is a tension between abundance of choice and choice burden for the consumer. At the same time, the presence of a plurality of options places a greater cognitive burden on the consumer, and this can lead to compromised decision quality and possibly sub-optimal outcomes. The cognitive burden may lie upon the consumer, including a representative of the consumer, e.g., a travel agent creating a travel itinerary for a consumer. The platform may provide the balance between “richness of options” and “choice overload,” along with considering conflicting objectives and values (e.g., a desire for luxury constrained by willingness-to-pay).

Thus, the platform has a choice architecture that pertains to how the choice task is structured, and how choice options are described or presented to the consumer. The choice architecture can be characterized by the following categories:

Logical/Rational Basis. The knowledge, information, and preferences that factor into the travel itinerary selection process can be structured and evaluated in a transparent and rationally consistent manner. The logical basis may formally include multiattributes in order to allow for proper trade-off analysis.

Speed and Efficiency. The choice architecture can provide results and itinerary solutions within time-frames that are compatible with the OTA decision context (i.e., on the order of a few seconds). Information and analysis can be presented to the consumer in an efficient manner, minimizing search costs and conveying essential information in ways that enable rapid identification of minimal choice sets, from which final purchase decisions can be made.

Awareness of Cognitive Biases and Heuristics. Consumers are known to invoke a number of heuristics and biases in evaluating travel options. For example, consumers can often perform an initial screening of options on the basis of some subset of total product attributes (e.g., cost), and then make alternative-based comparisons on the basis of the remaining attributes after the initial screening. Within the travel space, it is also not uncommon to see consumers use attribute information (e.g., seat choice) to predict en route or ex post satisfaction. The choice task for the average consumer can be, in fact, replete with cognitive biases. As consumers are often inclined to accept and use information in the form in which they receive it, the choice architecture of the platform may present information to the consumer in ways that minimize the adverse effects of cognitive biases that can adversely impact decision quality and consumer satisfaction.

Visualization Capabilities. It is important for consumers to be able to visualize the results of travel queries in ways that ultimately maximize decisional efficiency. At a minimum, the visualization schemes may, when presenting two or more travel itinerary options, convey rank information as well as information concerning the cause of the rank. The platform is able to convey information about “performance” (namely, suitability of the travel itinerary based on user preferences) vs. price by conveying maximal information to the consumer in an efficient and easy-to-understand manner. The interactive refinement and/or modification of travel search attributes is also a part of the decision aiding capabilities of the platform.

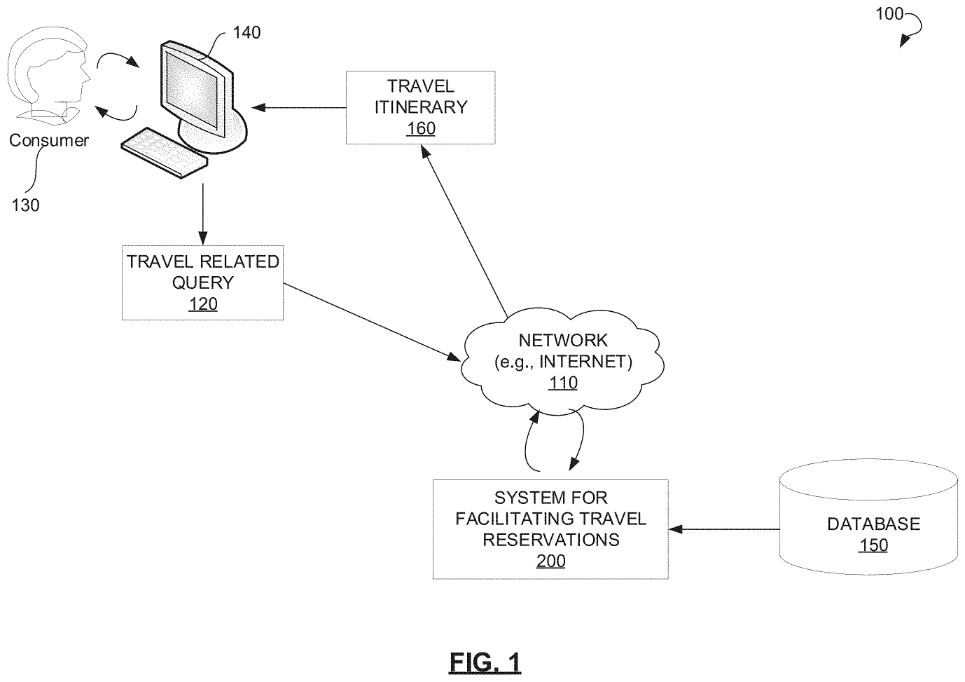

FIG. 1 illustrates an environment 100 within which the systems and methods for facilitating multi-passenger and multiattribute travel reservations can be implemented, in accordance with some embodiments. A travel related query 120 associated with a plurality of users or user preferences may be received, for example, via a user interface displayed on a computing device 140. The travel related query 120 may include free text data. The free text data may be obtained by a consumer 130 as a natural language input by the users, by speech-to-text conversion of an oral exchange with the users, or otherwise. In some embodiments, the consumer 130 may be asked, in oral or written form, one or more motivating questions to receive relevant travel-related query 120.

The travel-related query 120 may be transmitted to the system 200 for facilitating multi-passenger and multiattribute travel reservations via a network 110. The network 110 may include the Internet or any other network capable of communicating data between devices. Suitable networks may include or interface with any one or more of, for instance, a local intranet, a Personal Area Network (PAN), a Local Area Network (LAN), a Wide Area Network (WAN), a Metropolitan Area Network (MAN), a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or an Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System (GPS), cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may be a network of data processing nodes that are interconnected for the purpose of data communication. The network 110 may include any suitable number and type of devices (e.g., routers and switches) for forwarding commands, content, and/or web object requests from each client to the online community application and responses back to the clients.

The computing device 140, in some example embodiments, may include a Graphical User Interface (GUI) for displaying the user interface associated with the system 200. In a typical GUI, instead of offering only text menus or requiring typed commands, the system 200 may present graphical icons, visual indicators, or special graphical elements called widgets that may be utilized to allow the consumer 130 to interact with the system 200. The computing device 140 may be configured to utilize icons used in conjunction with text, labels, or text navigation to fully represent the information and actions available to the consumer 130.

The computing device 140 may include a mobile telephone, a personal computer (PC), a laptop, a smart phone, a tablet PC, an automated assistant, and so forth. The system 200 may be a server-based distributed application; thus it may include a central component residing on a server and one or more client applications residing on one or more computing devices and communicating with the central component via the network 110. The consumer 130 may communicate with the system 200 via a client application available through the computing device 140.

Travel itineraries available from the optional database 150 may be analyzed with reference to preferences of the users and travel itineraries 160 suiting the preferences of the users may be determined. Travel itineraries 160 may be presented to the consumer 130 by displaying travel itineraries 160 via the user interface on a screen of the computing device 140.

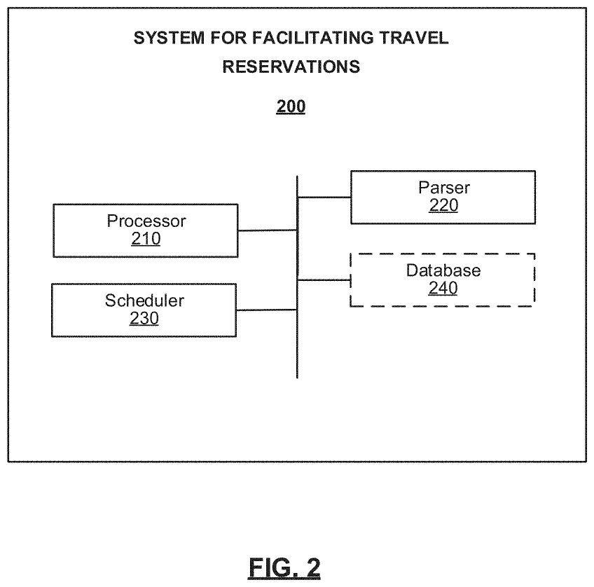

FIG. 2 is a block diagram showing various modules of the system 200 for facilitating multi-passenger and multiattribute travel reservations, in accordance with certain embodiments. The system 200 may comprise a processor 210, a parser 220, a scheduler 230, and an optional database 240. The processor 210 may include a programmable processor, such as a microcontroller, central processing unit (CPU), and so forth. In other embodiments, the processor 210 may include an application-specific integrated circuit (ASIC) or programmable logic array, such as a field programmable gate array, designed to implement the functions performed by the system 200.

The processor 210 may receive a travel related query. The travel-related query may be provided by one or more consumers, for example, by the consumer 130. Moreover, the travel related query may be provided using a natural language, a typed text, a selection of preexisting options, and so forth. Examples of typed text include an email, a Short Message Service (SMS) message, a Rich Communication Services (RCS) message, and a chat message. In a further embodiment, the travel-related query may be associated with a group of users. The processor 210 may ascertain an attribute set relevant to the travel related query. The attribute sets may include, for example, an origin city, a destination city, and a hotel for a first passenger; an origin city, a destination city, a hotel, and a car reservation for a second passenger; and an origin city, a destination city, a flight date, a hotel, and a destination city for a return flight for a third passenger.

The parser 220, being in communication with the processor 210, may be operable to parse the travel related query to derive attribute values related to the attribute set. The parser 220 may be further operable to initiate the at least one attribute of the attribute set with the derived attribute values. For example, if the travel-related query is ‘Book tickets for a flight from New York to Chicago for tomorrow,’ the multi-passenger travel booking platform derives the attribute value “New York” for the attribute set “Origin City,” the attribute value “Chicago” for the attribute set “Destination City,” and the attribute value, based on a current date, for the attribute set “Date.”

In an example embodiment, the at least one attribute with one possible value is a necessarily satisfied condition. In other words, the consumer may need to provide at least one attribute of the travel-related query.

Thereafter, the processor 210 may rank at least one attribute based on user preferences. The user preferences may be determined based on the travel related query. Additionally, the user preferences may be determined based on preexisting selections (for example, selections made by the user in a user profile associated with the system 200). The preexisting selections may be received from the user using a human-computer interface. Based on the ranking, the processor 210 may assign weights to the at least one attribute to create at least one weighted attribute.

The scheduler 230 may be operable to search for the feasible travel itineraries based on the least one attribute and the user preferences. The scheduler 230 may score the feasible travel itineraries based on the at least one weighted attribute for each of the feasible travel itineraries.

Upon scoring the feasible travel itineraries, the processor 210 may present at least one travel itinerary selected from the feasible travel itineraries based on the scoring. Additionally, the at least one travel itinerary and corresponding scores may be visualized to the consumer.

The optional database 240 may be configured to store at least data related to the travel related query, the user preferences, consumer heuristics and biases, and so forth.

Thus, the system 200 may be operable to customize, for each individual traveler, how travel itinerary options are identified and presented for purchase consideration. Furthermore, the choices, namely the travel itineraries, may be presented to the consumer in ways that minimize search cost and maximize path-to-purchase efficiency.

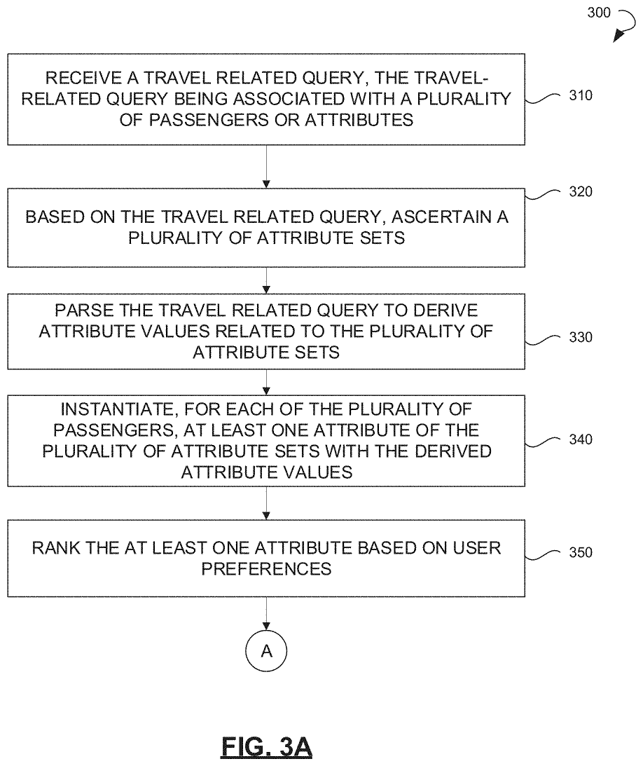

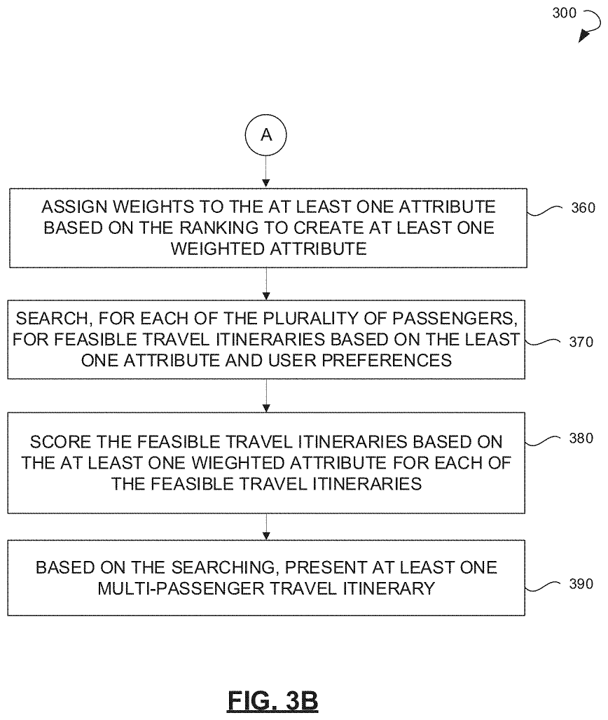

FIGS. 3A and 3B are process flow diagrams showing a method 300 for facilitating multi-passenger and multiattribute travel reservations within the environment described with reference to FIG. 1. The method 300 may commence with receiving a travel-related query associated with a plurality of passengers or attributes at operation 310. In an example embodiment, the travel-related query may be provided via at least one of the following: a natural language, a typed text, a selection of preexisting options, and so forth. In a further example embodiment, the travel-related query may be associated with a plurality of passengers, such as with a group of users.

The method 300 may continue with ascertaining a plurality of attribute sets relevant to the travel-related query at operation 320. At operation 330, the method may include parsing the travel related query to derive attribute values related to the plurality of attribute sets. In an example embodiment, a plurality of attributes, i.e., an attribute set relevant to the travel-related query, may be derived. The attributes may include parameters of the itinerary, such as a flight, a hotel, an origin city, a destination city, a departure date, an arrival date, time, prices, travel class, and other attributes, such as ground transportation options, tours, and the like. Each attribute may have an option. For example, the options for the ‘hotel’ attribute may include ‘hotel 1’ in a destination city, ‘hotel 2’ in the destination city, and any other hotels that may satisfy the travel-related query.

In an example embodiment, the at least one attribute with one possible value is a necessarily satisfied condition. In other words, the consumer may need to provide at least one attribute of the travel-related query.

Upon the parsing, for each of the plurality of attribute sets, at least one attribute of the attribute set may be initiated with the derived attribute values at operation 340. In an example embodiment, the at least one attribute with one possible value is a necessarily satisfied condition.

At operation 350, the at least one attribute may be ranked based on consumer preferences. In an example embodiment, the consumer preferences may be determined based on the travel related query. In another example embodiment, the consumer preferences may be determined based on preexisting selections. In another example embodiment, the consumer preferences may be determined by heuristics or biases. In another example embodiment, the consumer preferences may be determined by retrieving or analyzing historical data.

The method 300 may optionally comprise providing a human-computer interface to receive the preexisting selections from a consumer. More specifically, the method 300 may include a front-end instantiation of preferences and attributes, where the preferences and attributes are obtained by parsing the semantic intent underlying the travel related query. The method 300 may further include a back-end specification of the preferences and attributes by reading consumer-specified rank-order preference information (i.e., the preexisting selections) from a database (for example, the preference information related to airlines, hotels, etc.).

The method 300 may continue with operation 360, at which weights may be assigned to the at least one attribute based on the ranking. Thus, at least one weighted attribute may be created.

At operation 370, the method 300 may include searching for feasible travel itineraries for each of the plurality of passengers and multiattributes based on the least one attribute and the preferences. Upon the search, the feasible travel itineraries may be scored at operation 380. The scoring may be based on the at least one weighted attribute for each of the feasible travel itineraries. In example embodiments, the method 300 may optionally include adjusting the scoring based on forecasted weather conditions at a time of travel.

Upon scoring, the method 300 may continue with operation 390, at which at least one multi-passenger and multiattribute travel itinerary selected from the feasible travel itineraries for each of the plurality of attribute sets, based on the scoring, may be presented to the consumer. In example embodiments, the presenting of the at least one multi-passenger and multiattribute travel itinerary may include visualizing itinerary information and corresponding scores associated with each of the plurality of passengers and multiattributes.

The method 300 may further include receiving, by the processor 210, a revision request. The revision request may be associated with at least one of the plurality of users and may refer to an alteration of at least one of the attribute values or an addition of a further attribute value. Based on the revision request, the processor 210 may instantiate a further attribute with an altered derived attribute value or a further attribute value. Furthermore, based on the instantiation, the scheduler 220 may search for further feasible travel itineraries based on the further attribute.

In a further example embodiment, the presenting of the one multi-passenger and multiattribute travel itinerary may include identifying, by the processor 210, based on the assigned weights, one or more attributes having the highest weights. The one or more attributes having the highest weights may be visually marked out when being shown to the consumer.

In an example embodiment, the method 300 may further include selecting, by the processor, from the feasible travel itineraries, the at least one multi-passenger and multiattribute travel itinerary associated with the one or more attributes having the highest weights. Upon selecting, the selected at least one multi-passenger and multiattribute travel itinerary may be presented to the consumer as described above with respect to operation 390.

In some example embodiments, the presenting may further include providing visual cues associated with the one or more attributes that have the highest weights. Additionally, the presenting may include visualizing segments of the at least one multi-passenger and multiattribute travel itinerary. In a further example embodiment, the at least one multi-passenger and multiattribute travel itinerary for each of the plurality of users may be presented as a matrix (i.e., a table). The matrix may have a plurality of columns and a plurality of rows. Each of the columns may be associated with one of the plurality of users. Each of the rows may be associated with at least flight information. Each of the rows may be further associated with one or more of the following: hotel information, rental car information, return flight information, continuing flight information, and so forth.

The method 300 may be directed to determining how the utility, or value, the consumer derives from a given travel itinerary is characterized and evaluated. This utility may be derived from the defining elements of each travel itinerary (e.g., flight characteristics, such as class of service, etc.). Thus, the method 300 may be used for prioritizing and ranking itinerary options.

The operations of the method 300 and elements of the system 200 are further described in detail below.

### Specification of Relevant Attribute Sets

The system for facilitating travel reservations may support a travel lexicon to accommodate and fulfill a wide range of possible travel related query. Therefore, within the system, the travel related queries can be expressed via natural language (typed or spoken). The system may be operable to support basic travel queries, Q, which take the form of

Q={qₛ, q_{d}, qₜ}, where
qₛ [symbol] starting point (airport, city, etc.);
q_{d} [symbol] final destination;
qₜ [symbol] duration of trip.

Relative to the travel-related query, Q, the construction of feasible travel itineraries may involve routing and scheduling within a fixed-scheduled network with time-dependent travel times. It should be noted that the task of finding a path between any two nodes in the network (for example, an ‘Origin’ and a ‘Destination’) and the associated schedule for traversing that path in such a way that certain criteria are optimized (maximized or minimized) is a computation-intensive task. This routing/scheduling/optimization task becomes considerably more complex when one or more of the following itinerary features are present:
Itineraries comprising multiple passengers (for example, two or more);
In multi-passenger itineraries, coordination and scheduling of non-collocated (i.e., geographically distributed) passengers (e.g., scheduling travel for annual Board of Directors meetings, family reunions, and the like);
Multiple leg-segments and/or destinations;
Passenger-specific arrival and/or departure time preferences or constraints;
Other constraints:
Budget constraints (global or passenger-specific);
Desired performance-, service-, or routing-related attributes or constraints (e.g., early boarding, premium economy seating, desired hub connection, etc.);
Desired ancillary content.

Systematically handling travel-related queries that are characterized by one or more of these attributes requires sophisticated routing, scheduling, and optimization capabilities.

The scheduler 230 of the system 200 shown on FIG. 2 may be a purpose-built scheduler capable of handling complex travel-related queries. The system 200 may be operable to use distinctive axes, shapes, colors, and typography. These elements may have tie-ins to trademarked branding elements associated with the system, thereby allowing the consumer to associate the branding elements of the system 200 with the system 200.

The system 200 may display user-specific travel itinerary information relating to flights, hotels, and rental cars, and other ancillary content can be accommodated as well. Furthermore, the system 200 may incorporate a number of interactive features and design elements. The travel itineraries may be revisable for the consumer—wholly or in part—directly from the user interface of the system 200, e.g., via text or voice.

Structurally, the system 200 may be defined in terms of (i) the generic, defining elements of a travel itinerary, which includes user-specific flight, hotel, and car rental information; and (ii) specific attributes or ancillary content instantiated in the original travel-related query (such as desired star rating for hotel accommodations, etc.).

Each travel query, Q, can be contextualized or made more specific via attributes that are instantiated via the travel related query in natural language. Accordingly, the system may be operable to identify and specify attribute sets that are relevant to the travel related query (which, in fact, relates to goals and objectives expressed by the user in the travel related query). It is possible to reason about whether the goals and objectives are met in terms of attribute values. In the context of a travel itinerary, attribute values may include the desire for an aisle seat, a non-stop flight, and the like. Therefore, the system can be used to find a means by which it is possible to reason whether the travel itinerary is capable of providing specified attribute values.

Therefore, the processor of the system is operable to define relevant attribute sets (RAS) that are linked/tied to context-defining attribute values specified in the given travel query, Q. The attribute sets may pertain, specifically, to flights (F), hotels (H), and origin (O) and destination (D), and may be defined as follows:

RAS(Q,F)={f∈F|isRelevant_Flights(f,Q)=true};

RAS(Q,H)={h∈H|isRelevant_Hotels(h,Q)=true};

RAS(Q,O)={o∈O|isRelevant_O&D(o,Q)=true}.

In the characterization above, isRelevant_Flights is a logical predicate that asserts that attribute f is relevant for travel related attribute values specifiable in the travel related query, Q. Similar interpretations hold for the predicates isRelevant_Hotels and isRelevant_O&D.

Thus, the relevant attribute sets may be specified for flights, hotels, and origin and destination (O&D), respectively. For example, the RAS for Flights, RAS(Q, F), covers five attributes that may be supported within the travel lexicon of the parser of the system. These attributes, and their possible values, are shown in table 1 below.

TABLE 1

| RAS - | Attribute | |
|---|---|---|
| Flights | Name | Values |
| F₁ | Carrier | Air Canada, American Airlines, et al. |
| F₂ | Number of Stops | {0, 1, 2} |
| F₃ | Class of Service | Economy, Economy-Refundable, |
| | | Business-Restricted, Business- |
| | | Unrestricted |
| F₄ | Equipment | Airbus, Boeing, Embraer, et al. |
| F₅ | Desired | Local Time, relative to consumer's origin; |
| | Departure/Arrival | time at Desired Destination |
| | Time | |

The RAS for hotels, RAS(Q, H), are shown in table 2 below and may include five attributes that are typically encountered in hotel searches.

TABLE 2

| RAS - Hotels | Attribute Name | Values |
|---|---|---|
| h₁ | Hotel Chain | Hilton, Marriott, et al. |
| h₂ | Star Rating | {0, 1, 2, 3, 4, 5, 6, 7} |
| h₃ | Smoking Preference | Y/N |
| h₄ | Bed Type | Twin, King, etc. |
| h₅ | Hotel Name | Local Time (relative to User's |
| | | IP address) |

Finally, the RAS for O&D, RAS(Q,O), is shown in table 3 below and may enable the consumer to specify a country, city, city code, or airport code in a given travel request.

TABLE 3

| RAS - O&D | Attribute Name | Values |
|---|---|---|
| o₁ | Country | Argentina, United States, United |
| | | Kingdom, et al. |
| o₂ | City | London, Toronto, Washington, et al. |
| o₃ | City Code | WAS, et al. |
| o₄ | Air Port Code | AUS, BOI, SEA, et al. |

### Parser-Enabled Instantiation of Attributes

As mentioned above, the capabilities of the system can be utilized to contextualize and add specificity to travel related requests, thereby enabling the consumer to explicitly specify sought after or desired attribute values. The RASs defined above make it possible to operationalize the “front-end” and “back-end” integration discussed above. In this regard, it may be explored what this front-end portion means for any set of the attributes contained in each RAS to be activated or instantiated within the context of a given travel related query, Q.

Generally speaking, the fulfillment of a travel related query may require the instantiation of one or more attributes. These instantiated attributes enable adding context or specificity to the travel related query. For this purpose, the Cartesian product, Z, of three relevant attribute sets may be defined:

Z=F×H×O,

which, given the specifications for F, H, and O, above, gives rise to the following ordered n-tuple:

z=(f1,f2,f3,f4,f5,h1,h2,h3,h4,h5,o1,o2,o3,o4). (1)

If vector notation is used and if F=[f₁, f₂, f₃, f₄, f₅], H=[h₁, h₂, h₃, h₄, h₅], and O=[o₁, o₂, o₃, o₄], then Equation (1) can be expressed succinctly as follows:

Z=[F,H,O]. (2)

In the context of a given travel related query, Q, Equations (1) and (2) can be used for representing those attributes that are instantiated within the travel related query. Some of the travel attributes may be instantiated on a continuing basis, in that the attributes may represent characteristic features of any feasible travel itinerary (e.g., every travel itinerary containing flights can be characterized by one or more air carriers, and so forth).

For the purpose of this disclosure, it can be assumed that instantiability is binary-valued. The space of all possible instantiations of the attributes is of order 2n=2¹⁴, and is defined as the cross product of the binary-valued state space associated with each individual attribute.

This scheme describes which travel attributes matter to the consumer. In general, the more attributes that are ascertained, the more specific the travel related query is. Therefore, the travel related query may be assumed to be closed with respect to a given RAS and a given query, Q, if all the attributes contained within the set of attributes are instantiated. Conversely, the travel related query may be assumed to be open if only a partial (possibly empty) subset of travel attributes is ascertained.

Further, let Z(Q) denote a query-driven set of ascertained attributes, and ‘*’ denote those attributes that are non-ascertained. Therefore, a query-driven set of the ascertained attributes may be represented as follows:

Z(Q)=(f₁,f₂,*,*,f₅;h₁,*,*,h₄,*;*,*,*,o₄). (3)

In Equation (3), query Q ascertains three of our travel related attributes: f₁, f₂, and f₅ (i.e., the natural language request specifies user preferences pertaining to ‘Carrier,’ ‘Number of Stops,’ ‘Class of Service,’ and ‘Desired Departure Time’). The query Q also ascertains hotel-related attributes pertaining to ‘Hotel Chains’ and ‘Bed Type,’ together with the origin and destination attribute pertaining to ‘Airport Codes.’ Therefore, for the travel related attributes, Equation (3) is open with respect to attributes 3 and 4; for the hotel attributes, Z(Q) is open with respect to attributes 2 and 3; and for the origin and destination attributes, the travel related query is open with respect to attributes 1, 2, and 3.

### Multiattribute Formulation—Preliminaries

The system further utilizes the RASs specified above to associate a determinate value with each travel itinerary as a function of the ascertained attributes that are associated with a given travel related query. In this way, each feasible itinerary may be characterized in terms of a single, aggregate (dimensionless) value, which may be used to prioritize and rank itinerary attributes.

The key elements for performing prioritizing and ranking may include: a finite number of travel itineraries, [symbol] ; a finite number of attributes, l; a weight, wᵢ, for each attribute i∈l; a value score for each attribute and itinerary, vᵢ(a), for itinerary a∈ [symbol] and attribute i∈l; and total value, V, of itinerary a∈ [symbol] defined as the weighted sum Σᵢ wᵢvᵢ(a).

Alternatively, using the vector notation introduced earlier, the total value of an itinerary choice set is succinctly expressed as

V(F,H,O)=Σwv(⋅)

where w denotes vector tradeoff weights for F, H, O. For ease of analysis and exposition, it is convenient to also assume that

∀i∈l,wᵢ≥0 and Σᵢwᵢ=1;

∀a∈ [symbol] and i∈l,vᵢ(a)∈[0,1],

and for each i∈ [symbol] , there are a′, a″∈ [symbol] ∃vᵢ(a′)=1 and vᵢ(a″)=0; itinerary a′ is at least as preferred as itinerary a″ if wv(a′)≥wv(a″).

The next step is to integrate front-end attribute ascertaining and back-end-specified consumer preferences. This may require some mathematical preliminaries described below.

### Mathematical Preliminaries

As discussed earlier, it is necessary to take into consideration the relationship between a “front-end” of the system (where parser-enabled attribute instantiations occur) and a “back-end” of the system (where consumers provide profile information that contains preference information). For this purpose, permutations on lexicographically ordered finite sets can be used, where each permutation contains information pertaining to the rank-order preferences of the consumer (for example, for airlines, hotels, and the like).

The back-end-specified rank-order preference information can be utilized to impute numerical values, which serve as the primary means by which numeric specifications for the value functions may be determined: vᵢ(a).

The concept of a permutation can enable explicitly referencing/indexing rank-order preference data obtained via “user profiles” on the back-end of the system. For this purpose, let S denote a finite set consisting of n elements:

S={x₁, x₂, . . . , xₙ}.

For ease of exposition and analysis, the restriction can be imposed that the elements of S are lexicographically ordered such that

x₁≤x₂≤ . . . ≤xₙ.

The kind of permutation, n, is a bijection, i.e., a one-to-one and onto function from S onto itself:

π:S→S.

Example 1. Let S={x₁, x₂, x₃, x₄, x₅}, with the following illustrative graph of π: π(x₁)=x₂, π(x₂)=x₃, π(x₃)=x₁, π(x₄)=x₅, and π(x₅)=x₄. This permutation can be expressed in matrix form as

$$π = ( \begin{matrix}{x}_{1} & {x}_{2} & {x}_{3} & {x}_{4} & {x}_{5} \\ {x}_{2} & {x}_{3} & {x}_{1} & {x}_{5} & {x}_{4}\end{matrix} ) \qquad ( 4 )$$

If the lexical order described above is treated as fixed, the permutation can be expressed in its simpler Cartesian form:

π=[x₂,x₃,x₁,x₅,x₄]. (5)

Example 2. As a travel-specific example, there are the following 5 airlines, listed in alphabetical order in table 4:

TABLE 4

| Lexical Element | Airline |
|---|---|
| x₁ | American |
| x₂ | Jet Blue |
| x₃ | Southwest |
| x₄ | United |
| x₅ | Virgin America |

The consumer may provide the following rank-order preference information for this set of airlines:

### Virgin America>Southwest>United>American>Jet Blue.

This preference ordering can be representable by:

π=[5,3,4,1,2]. (6)

This example can be generalized to an arbitrary n:

π=[i₁, i₂, . . . , iₙ], (7)

where π∈Sₙ and π(x₁)=xᵢ_{₁}, π(x₂)=xᵢ_{₂}, . . . , π(xₙ)=xᵢ_{ₙ}.

### Imputation of Marginal Value Functions via Rank-Ordered Preferences

Equation (7) can be utilized to encode preference information concerning air carriers, hotels, and the like. As described below, each permutation vector is used to impute numerical weights of relative importance or value for these vector elements. For the purposes of this disclosure, two numerical approaches can be utilized, namely rank sum and rank reciprocal.

Rank Sum (RS). N attributes or lexicographically ordered elements are ranked, and each attribute is weighted according to the formula,

$${w}_{i} = \frac{N - {r}_{i} + 1}{{Σ}_{j} ( N - {r}_{j} + 1 )} , \qquad ( 8 )$$

where rᵢ is the rank position of the attribute or element.

Rank Reciprocal (RR). Weights are derived from the normalized reciprocals of a rank of the attribute or element:

$${w}_{i} = \frac{1 \text{/} {r}_{i}}{{Σ}_{j} ( 1 \text{/} {r}_{j} )} . \qquad ( 9 )$$

Example 3. Applying Equations (7), (8), and (9) to the airline of Example 2 yields the numerical values shown in table 5 below.

TABLE 5

| Airline | Rank | RS Weight | RR Weight |
|---|---|---|---|
| American | 4 | 0.133 | 0.109 |
| Jet Blue | 5 | 0.067 | 0.088 |
| Southwest | 2 | 0.267 | 0.219 |
| United | 3 | 0.200 | 0.146 |
| Virgin America | 1 | 0.333 | 0.438 |

### Indexing the Multiattribute Value Model

Within the context of a given travel related query, only the attributes that are instantiated are taken into consideration. Therefore, the instantiated attributes need to be indexed. To this end, a travel related query, Q, gives rise to a vector Z(Q) of instantiated attributes. For example, the travel related query, Q, generates the following attribute instantiations:

(f₁, f₂, *, *,f₅; h₁, *, *, h₄, *; *, *, *, o₄),

in which case

Z(Q)=(f₁,f₂,f₅;h₁,h₄,o₄). (10)

From Equation (10), three index sets can be extracted, which enable indexing multiattribute aggregation model:

### I_{F}={1,2,5}

### I_{H}={1,4}

### I_{O}={4}.

In more general terms, the index sets illustrated above can be defined as follows:

I_{F}={i|i∈F and fᵢ∈Z(Q)=true}; (11)

I_{H}={(j|j∈H and hⱼ∈Z(Q)=true}; (12)

I_{O}={k|k∈O and oₖ∈Z(Q)=true}. (13)

Having properly indexed the instantiated attributes that the travel related query, Q, gives rise to, the multiattribute aggregation model described earlier can be specified in the specialized form that its application here requires:

$${V}_{Q} ( F , H , O ) = {\sum }_{i ∈ {I}_{F}} {w}_{i} {v}_{{f}_{s}} ( \cdot ) + {\sum }_{j ∈ {I}_{H}} {w}_{j} {v}_{{h}_{j}} ( \cdot ) + {\sum }_{k ∈ {I}_{O}} {w}_{k} {v}_{{o}_{k}} ( \cdot ) . \qquad ( 14 )$$

The linear additive nature of Equation (14) enables using the portions of the aggregation model that are required by the travel related query, Q. For example, the travel related query that only requests a flight itinerary will utilize only the first of the three summations shown in Equation (14).

The numerical specification of Equation (14) is essentially a two-step process and includes a specification of the relevant single attribute value functions v_{fi}(⋅), vₕⱼ(⋅), and yₒₖ(⋅), and a specification of the (scaling) weights wᵢ, wⱼ, and wₖ. Each of these elements can be considered in turn.

### Specification of Single-Attribute Value Functions—Flights

In specifying the single-attribute value functions, v_{fi}(⋅) associated with flights, there is reason to presume the existence of a set, [symbol] , of feasible itinerary solutions (FISs), comprised of elements a₁, a₂, . . . , aₘ. In the case of a travel related query, each travel itinerary aᵢ∈ [symbol] is evaluated on attributes F₁, . . . , Fₘ and a marginal value function, vⱼ(fᵢⱼ), on the performance fᵢⱼ of the travel itinerary aᵢ under attribute Fⱼ. Each of these five travel related attributes is considered below.

Carrier (F₁). This attribute captures the preferences of the consumer related to an airline carrier. In the context of travel related queries, this attribute exists on a continuous basis, in the sense that every itinerary that involves air travel is characterized by a determinate carrier value.

In formally characterizing this attribute, it is distinguished between two types of travel related requests: those where the consumer expresses an explicit, named preference for one or more airlines (e.g., “Please show me all of the United flights from IAD to SFO for Friday”; “Can I see what Virgin or American flights I can take next Monday to London?”, etc.) and those where no such preference is expressed. From a consumer choice perspective, the request for a specific carrier (or set of carriers) acts as a filter: if the scheduler is able to return one or more feasible solutions that satisfy the travel related query, then those travel itinerary options are presented to the consumer for consideration, and the multiattribute value model is invoked only if other travel related attributes in RAS(Q, F) have been instantiated.

In all other instances involving travel related queries, each feasible itinerary solution aᵢ∈ [symbol] must be evaluated on attribute F₁. To this end, the marginal value function v₁(fᵢ₁) needs to be characterized and evaluated on the performance fᵢ₁ of itinerary aᵢ∈ [symbol] under this attribute. Equation (14) serves as the basis for a numeric scheme that enables the single-attributed scoring of each feasible itinerary solution yielded by the Scheduler, as measured by the Carrier attribute.

Since the number of carriers is finite, it can be assumed that F₁ is characterized by a finite domain D_{F1}. Numeric characterization of the marginal value function can proceed along several possible lines. It is possible to envision systematic attempts at the elicitation of consumer preferences regarding air carriers. Alternatively, it is also possible to envision schemes whereby these carrier preferences are learned over time in a systematic manner. The approach adopted herein exploits the existence of stated preference information provided on the back-end of the system. This information takes the form of rank-order preference data concerning air carriers, and this data is used, in conjunction with the RS and RR equations described earlier, to arrive at a numeric characterization for v₁(fᵢ₁).

Furthermore, the existence of a set, C, consisting of a lexically-ordered set of air carriers is presumed:

C={C1, C2, . . . , Cn}.

Given this set, the existence of a permutation vector, n_{c}, is presumed, and the vector encodes rank-order preference information for the air carriers contained in C:

π_{c}=[π_{c}¹, . . . π_{c}ⁿ].

Equation (8) can now be re-written as follows:

$${w}_{i}^{c} = \frac{n - {π}_{c}^{i} + 1}{{Σ}_{j} ( n - {π}_{c}^{j} + 1 )} , i = 1 , … , n \qquad ( 15 )$$

which provides a rank-order-derived importance weight, w^{c}ᵢ, for carrier i.

Further, each travel itinerary [symbol] ={a1, . . . , a2} is scored on attribute F₁. It is assumed that each travel related itinerary aᵢ ∈ [symbol] is characterized by a determinate carrier value xᵢⱼ^{k}=xᵢⱼ¹=cᵢ∈C, where i indexes travel itineraries (i.e., i=1, . . . m), j indexes carriers (i.e., j=1, . . . , n), and k indexes the instantiated (ascertained) attributes. Given this domain characterization, the marginal value function F can be characterized as follows:

$${v}_{1} ( {x}_{ij} ) = \{ \begin{matrix}{w}_{{π}_{c}^{j}}^{c} , & if {a}_{i} ∈ 𝒜 and {x}_{ij} \neq ∅ \\ 0 , & otherwise , \end{matrix}$$

where

$${w}_{{π}_{c}^{j}}^{c}$$

is the rank-order-derived weight, obtained via Equation (15), associated with carrier π_{c}^{j}, j=1, . . . , n.

Number of Stops (F₂). When instantiated, this attribute captures the consumer preferences for the number of leg segments contained within a given Origin and Destination city pair. Generally speaking, most travelers prefer less stops to more, but often this convenience comes at a cost (i.e., it increases the cost associated with an itinerary). For the purposes of this disclosure, this attribute is modeled as a constructed attribute, defined in terms of three attribute levels shown in table 6:

TABLE 6

| Attribute level | State |
|---|---|
| 0 | If Non-Stop |
| 1 | If 1-Stop |
| 2 | If 2-Stop |

The baseline parameterization for the single-attribute value function, v₂(⋅), is given as follows:

v₂(0)=1
v₂(1)=0.7
v₂(2)=0.

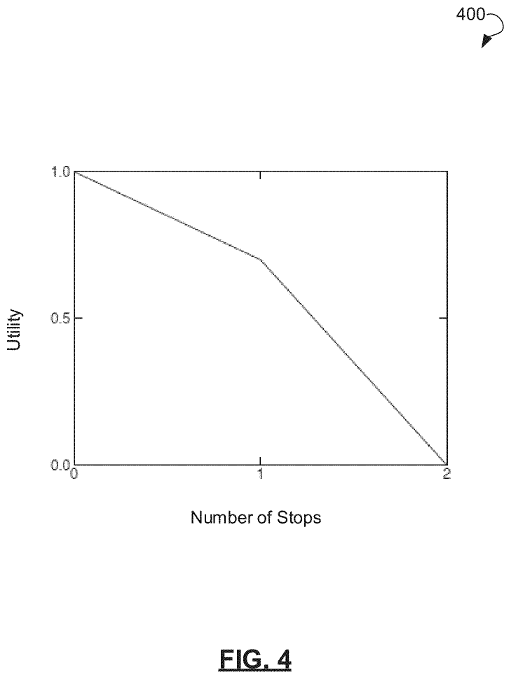

FIG. 4 shows dependency of utility of the travel itinerary (namely, matching of the travel itinerary with the consumer preferences) on a number of stops of the travel itinerary.

Class of Service (F₃). This attribute captures the consumer preferences for the specific classes of service offered by most airlines. When this variable is instantiated, the consumer is expressing a preference for a particular class of service. In looking, then, to measure the contribution to overall value that the instantiation of this attribute has on the overall value of a given itinerary, it is necessary to capture the conditional nature of this marginal value proposition. For this purpose, an “Ask/Get” matrix can be used, which, for the purposes of this disclosure, is defined as shown in table 7:

TABLE 7

| | | Econ.- | Bus.- | Bus.- |
|---|---|---|---|---|
| | Economy | Refundable | Restricted | Unrestricted |
| “Economy” | 0.9 | 0.6 | 0.1 | 0 |
| “Econ.- | 0.6 | 0.9 | 0.2 | 0 |
| Refundable” | | | | |
| “Bus.-Restricted” | 0 | 0.4 | 0.9 | 0.6 |
| “Bus.- | 0.1 | 0.5 | 0.7 | 0.9 |
| Unrestricted” | | | | |

In Table 7, the column entries contained in quotes (“Economy,” “Econ.-Refundable,” “Bus.-Restricted,” “Bus.-Unrestricted”) denote the actual consumer-provided travel related query, whereas the row entries denote the class of service associated with a given itinerary, aᵢ∈ [symbol] . If, for example, the consumer asks for a “Business-Restricted” ticket, but the feasible itinerary choice is an Economy-Refundable ticket, then that itinerary is assigned a weight of 0.4.

Equipment (F₄). This attribute becomes instantiated when the consumer expresses an explicit equipment-related preference. The consumer may, for example, request a wide-body plane (e.g., an A380, A340, etc.). Within the parser, such travel related query can be invoked at various levels of aggregation, e.g., body type, model type, and so forth. For ease of analysis, v₄(.) is characterized an indicator variable, where a travel related query, Q, containing a specific equipment-related request gives rise to one or more travel itinerary options that either succeed or fail to satisfy the equipment request. Accordingly, the weight function is formally specified as follows:

$${v}_{4} ( {x}_{i} ) = \{ \begin{matrix}1 , & if for itinerary {a}_{i} ∈ 𝒜 , DesiredEquipment = true \\ 0 , & otherwise , \end{matrix}$$

where DesiredEquipment is a logical predicate that returns a truth-value obtained via look-up tables (may be stored in the database) that define the relevant set of equivalence classes. For the purposes of this disclosure, for the wide/narrow body distinctions, the basic taxonomy supported within the parser is shown in table 8 below.

TABLE 8

| Wide Body | Narrow Body | Narrow Body |
|---|---|---|
| Jet | Jet | Continued |
| Airbus: 380, A330, | Airbus: A319, A320, | Embraer: E170/5, E190/5, |
| A340, A350 | A321 | EMB120, ERJ145 family |
| Boeing: B787, | Boeing: B737, B757, | Bombardier: CRJ, Dash-8 |
| B777, B767, B747, | MD83/90 | |
| MD-11 | | |

For example, if the consumer requests, within a given query, a wide-body plane, and a travel itinerary contains any of the jets listed in the first column of table 8 above, then the weight function is assigned a value of 1; otherwise it is assigned a zero.

Desired Departure/Arrival Time (F₅). Time factors into the travel plans and desires of most consumers. For example, typical requests may include the following: “I need to be in Los Angeles first thing Monday morning for a meeting”; “For my trip to New York, I'd like to arrive in New York in time to have dinner with Jonathan,” and the like. The system has the ability to include attributes that allow capturing and representing these kinds of time-related preferences. Accordingly, two attributes that capture/represent preferences pertaining to desired departure and arrival times, respectively, can be used.

In the first of these two instances, preferences pertaining to a desired departure time (DDT) of consumer need to be captured. When instantiated, the DDT can be expressed precisely as a time of day (12- or 24-hour format), or as a time-period (e.g., “morning,” “afternoon,” “evening,” or other possible sub-categories within these general categorizations). In practical terms, the marginal value function, v₅(xj), focuses on the relative duration of period between the departure time associated with the outbound flight (OF) associated with itinerary aᵢ ∈ [symbol] , and the stated DDT.

The preference levels associated with xi can be specified in any number of ways. For the purposes of this disclosure, the following four attribute levels are specified in table 9:

TABLE 9

| Attribute Level | State |
|---|---|
| 0 | if N/A; |
| 1 | if the OFᵢ for aᵢ ∈ [symbol] is within 1 hour of the DDT; |
| 2 | if, for aᵢ ∈ [symbol] , 1-hr <\|DDT − OFᵢ\| < 2-hrs; |
| 3 | if, for aᵢ ∈ [symbol] , \|DDT − OFᵢ\| > 2-hrs. |

This value function can be parameterized as follows:

v₅(0)=0
v₅(1)=0.9
v₅(2)=0.7
v₅(3)=0.4.

Furthermore, travel related queries that specify a desired arrival time (DAT) may be considered. In defining this attribute, as before, a constructed scale that measures the duration of period between the DAT of the consumer and the arrival time of a destination leg/flight (DF) of the travel itinerary is shown in table 10:

TABLE 10

| Attribute Level | State |
|---|---|
| 0 | If N/A; |
| 1 | if the DFᵢ for aᵢ ∈ [symbol] is within 1 hour of the DAT; |
| 2 | if, for aᵢ ∈ [symbol] , 1-hr <\|DAT − DFᵢ\| < 2-hrs; |
| 3 | if, for aᵢ ∈ [symbol] , \|DAT − DFᵢ\| > 2-hrs. |

This value function can be parameterized as follows:

v₅(0)=0
v₅(1)=0.9
v₅(2)=0.7
v₅(3)=0.4.

### Specification of Single-Attribute Value Functions—Hotels

The other attributes may include Hotel Chain, Star Rating, Smoking Preference, Bed Type, and the like.

For the Hotel Chain attribute (h₁), the indicator variable may be stated as follows:

$${v}_{{h}_{1}} = \{ \begin{matrix}0 , if x = N \\ 1 , if x = Y .\end{matrix}$$

For the Star Rating attribute (h₂), the indicator variable may be stated as follows:

{0, 1, 2, 3, 4, 5, 6, 7}.

For the Smoking Preference attribute (h₃), the indicator variable may be stated as follows:

$${v}_{{h}_{3}} = \{ \begin{matrix}0 , if x = N \\ 1 , if x = Y .\end{matrix}$$

For the Bed Type attribute (h₄), the Ask/Get Matrix may be used as discussed above.

The Hotel Name attribute (h₅) may be instantiated when the consumer mentions a hotel by name. If the hotel is available, the attribute has utility; if the hotel is unavailable, then the attribute has little or no utility.

Other Single-Attribute Value Functions relating to Origin and Destination may include country (o₁), city (o2), city code (o₃), airport code (o4), and so forth.

Numerical Case Study. Case: Flights-Only Itineraries

In an example embodiment, a travel related query, Q, is passed through the analytic framework of the system specified above. The travel related query may read as follows: “Roy and Jonathan want to travel non-stop from Toronto to Seattle on March 21st; we want business class seats, if possible; if possible, it would be nice to get there early enough in the evening to have dinner at Daniel's Broiler in Bellevue; as always, we prefer a wide-body plane.”

The travel related query instantiates the following flight attributes: F₁ (since a flight itinerary is desired), F₂ (since a non-stop flight is desired), F₃ (since business class seats are desired), F₄ (since a wide-body plane is preferred), and F₅ (since a desired arrival time—“Supper”=“Evening”—is specified). Therefore, this travel related query is closed under F, and, via Equation (7), gives rise to the following index set: I_{F}={1, 2, 3, 4, 5}.

The consumer may preliminarily create, on the back-end of the system, a user profile for at least one of the travelers (for example, Roy) that contains personal rank-order preferences for air carriers. Therefore, airline preferences of this traveler may be captured. Furthermore, the consumer may also preliminarily provide the rank-order preference information regarding the travel related attributes. Given this set of rankings, it may be determined that, when evaluating travel itinerary selection, the traveler assigns highest importance to obtaining a desired cabin class, followed by trip duration. Using these rank-order preferences, Equation (15) can be used to impute the RS weights shown below in table 11:

TABLE 11

| RAS - Flights | Rank | Rank Sum Weight |
|---|---|---|
| F₁ | 4 | 0.133 |
| F₂ | 2 | 0.267 |
| F₃ | 1 | 0.333 |
| F₄ | 5 | 0.067 |
| F₅ | 3 | 0.200 |

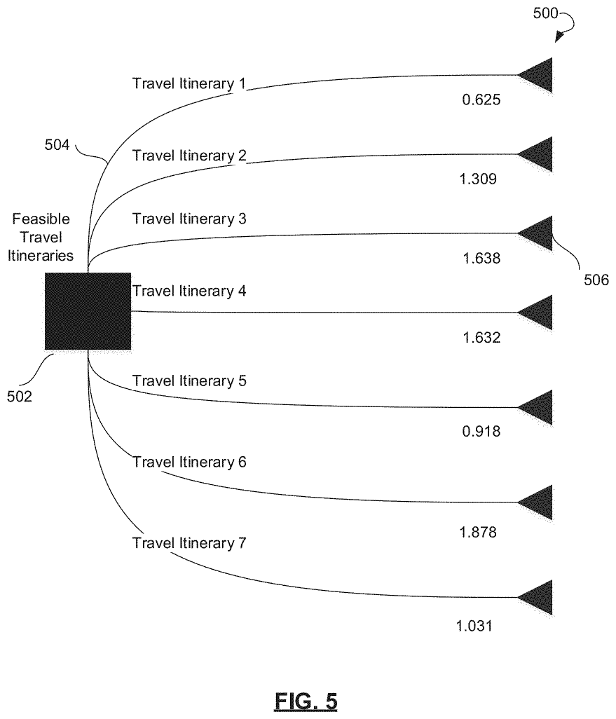

The scheduler may factor the preferences of the traveler into the search performed by the scheduler. FIG. 5. shows a representation 500 of travel itineraries found by the scheduler. In particular, the scheduler may perform the search in feasible travel itineraries 502. As a result of the search, travel itineraries 504 (shown as travel itineraries 1-7) may be found. Each of the travel itineraries 504 may have a weight 506.

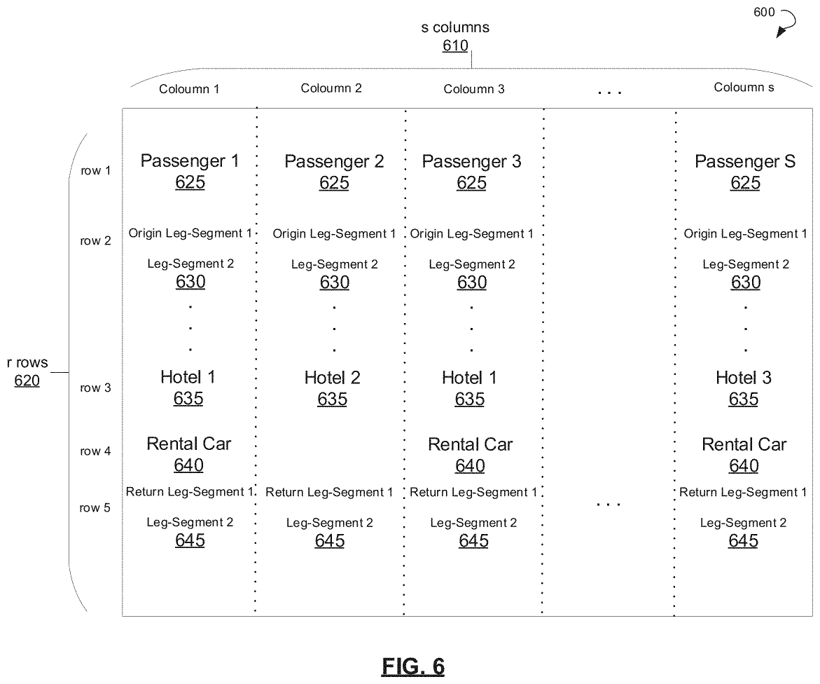

FIG. 6 shows a matrix 600 which can be used to provide a representation of the travel itineraries to the consumer. The matrix 600 may be comprised of s columns 610, each denoting names 625 of users and travel attributes contained in the travel-related query, and r rows 620 that partition each of the columns 610 into regions that convey attribute-specific information pertaining to flights 630, hotels 635, and rental car reservations 640. The matrix 600 may be represented as an (r×s) matrix Z; the row elements associated with each column j=1, 2, . . . , s. For example, the matrix may be characterized as follows:
Row 1: For z_{1J} ∈Z, a name 625 of the j^{th} passenger;
Row 2: Passenger-specific information pertaining to flights 630: flight leg segments associated with an origin city of the j^{th} passenger;
Row 3: When relevant and instantiated within the travel-related query, accommodations related to hotels 635 for the j^{th} passenger;
Row 4: When relevant and instantiated within the travel-related query, rental car reservations 640 for j^{th} passenger;
Row 5: Flight leg-segments 645 for return or continuing flights; and so forth.

The system for facilitating multi-passenger and multiattribute travel reservations can be used to accommodate an arbitrary number of passengers and attributes. The only limitations may be practical limitations involving factors such as screen size, font point size, and the like.

Viewed holistically from a consumer-experience perspective, the system for facilitating multi-passenger and multiattribute travel reservations may be designed in a manner that enables the consumer to focus on the defining elements of a multi-passenger and multiattribute travel itinerary, with a view towards enabling the consumer to identify itinerary options that are most likely to maximize utility (such as prove satisfying or requisite for the users). Therefore, the system for facilitating multi-passenger and multiattribute travel reservations may be intended to encourage flow in the creation of customized itineraries. Within the system, flow may be evaluated in terms of speed, visual cues, graphical representations of travel segments, interactivity/revise-ability, and so forth.

In an example embodiment, the system for facilitating multi-passenger and multiattribute travel reservations may be configured to evoke or engender a number of emotional and/or affective responses from the consumer. Insofar as the system for facilitating multi-passenger and multiattribute travel reservations provides the visual representation of analytic capabilities, speed, and utility of the system, the system for facilitating multi-passenger and multiattribute travel reservations is directed to engender in the consumer a sense of “the best selected travel itinerary,” or a sense that the system for facilitating multi-passenger and multiattribute travel reservations endeavors to make the path-to-purchase for the consumer as easy as possible.

To the extent that people perceive “attractive” things as more “usable,” the system for facilitating multi-passenger and multiattribute travel reservations may strive to achieve an overall aesthetic that conveys simplicity for the consumer. Furthermore, use of the system for facilitating multi-passenger and multiattribute travel reservations may be ultimately intended to be pleasurable for the consumer.

The system for facilitating multi-passenger and multiattribute travel reservations may be operable to provide collaborative capabilities, thereby enabling groups of two or more users to collaboratively construct travel itineraries. These features are intended to engender a sense of collaboration, community, and group creation.

Therefore, the system for facilitating multi-passenger and multiattribute travel reservations may convey to the consumer all of the information necessary to make an informed decision related to the purchase of the travel itinerary.

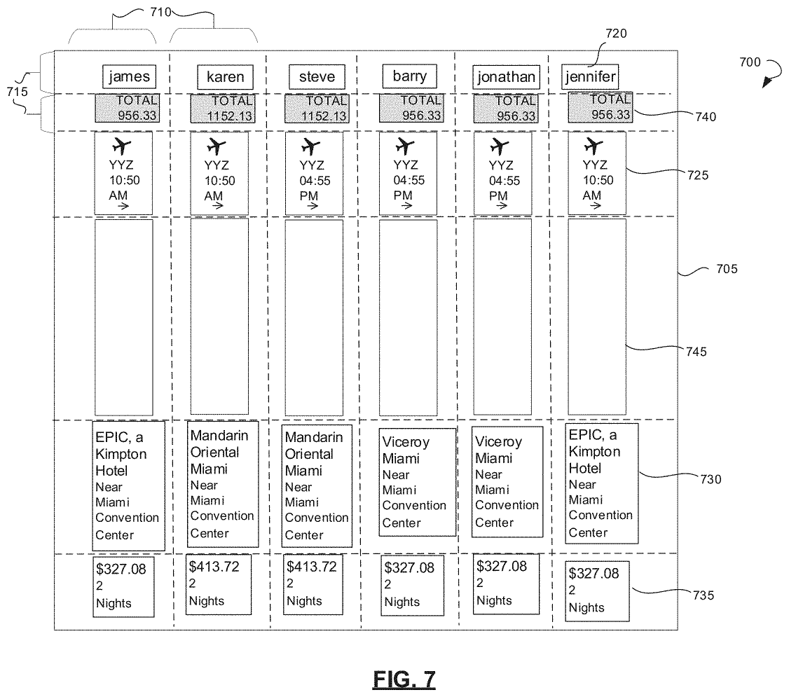

FIGS. 7-16 show example user interfaces provided by the system for facilitating multi-passenger and multiattribute travel reservations.

FIG. 7 is a diagram 700 showing an example user interface displaying results of a search for a multi-passenger and multiattribute travel itinerary for several passengers. The results may be represented in a form of a matrix 705 having columns 710, with one column for each set of attributes. The matrix 705 may also have a plurality of rows 715. The rows 715 may display attribute-specific information, such as a name 720 of the passenger, flight time 725, hotel information 730, a hotel price 735, a total sum 740 for the whole travel itinerary, travel policy constraints, and other information 745. Some segments of the matrix 705 may be visually marked, such as total sum 740 marked grey on FIG. 7.

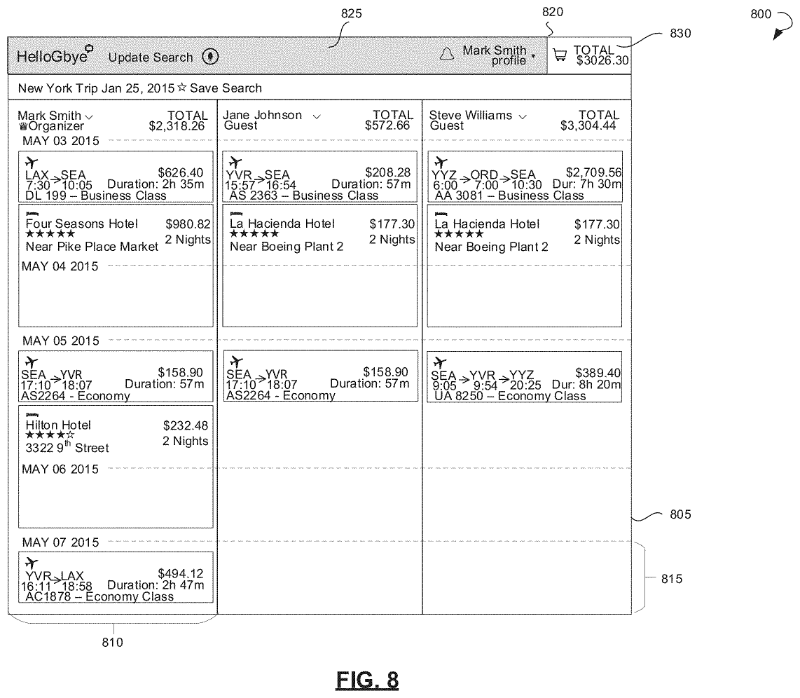

FIG. 8 is a diagram 800 that shows a user interface 820 representing a matrix 805 for displaying a multi-passenger and multiattribute travel itinerary for several passengers, according to an example embodiment. The matrix 805 may have columns 810 and rows 815. Each of the columns 810 may be associated with one passenger. The user interface 820 may include a section 825 displaying information related to a user profile that sends a travel-related query. Additionally, a total sum 830 for all feasible itineraries may be displayed on the user interface 820.

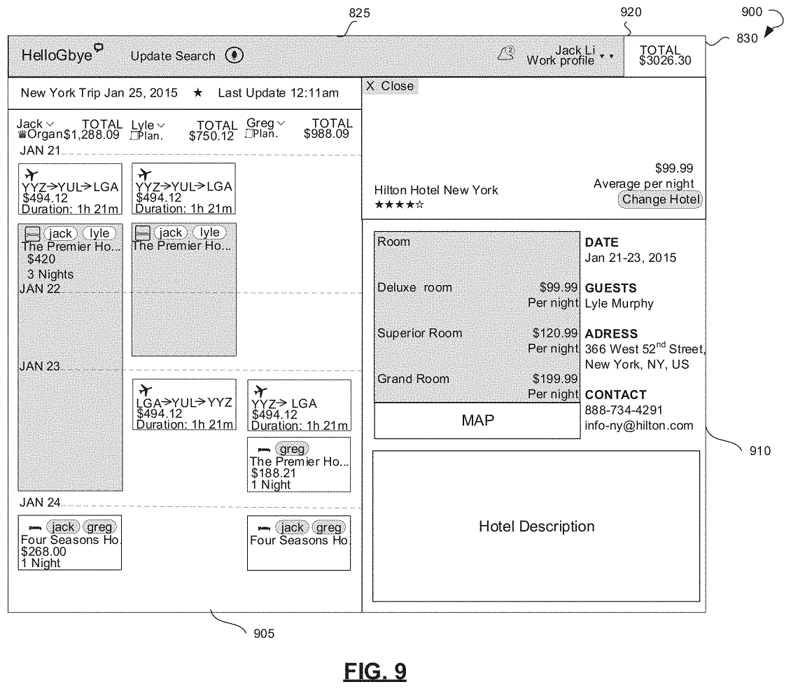

FIG. 9 is a diagram 900 that shows another user interface 920, according to an example embodiment. The user interface 920 may display a matrix 905 for displaying a multi-passenger and multiattribute travel itinerary for several passengers and a hotel description section 910. A consumer may select a hotel to be displayed in the hotel description section 910. The hotel shown in the hotel description section 910 may include a hotel selected for the one or more passengers of the multi-passenger travel itinerary. In an example embodiment, the consumer may close the hotel description section 910 if not needed.

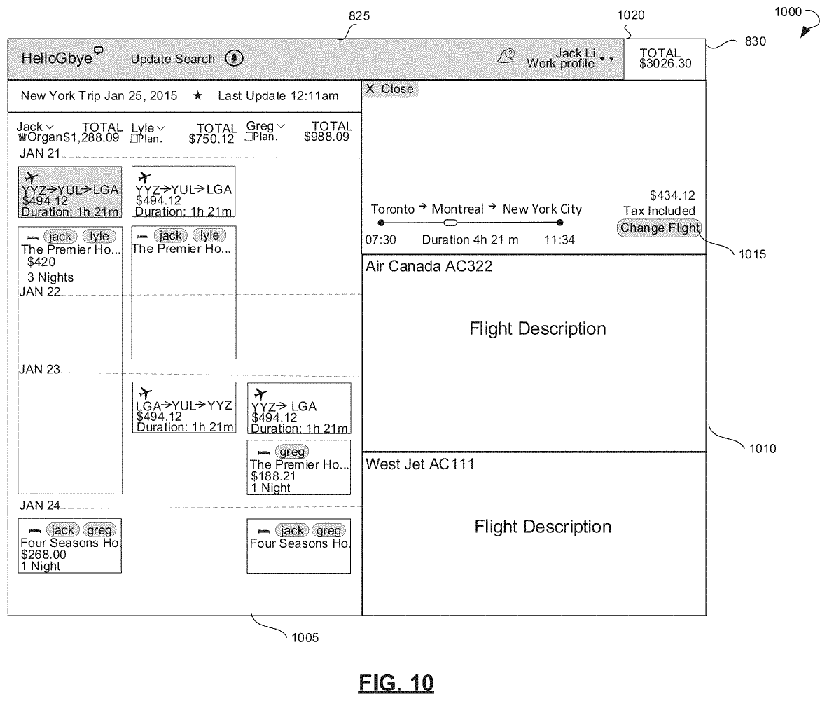

FIG. 10 is a diagram 1000 that shows a user interface 1020, according to an example embodiment. The user interface 1020 may display a matrix 1005 for displaying a multi-passenger and multiattribute travel itinerary for several passengers and a flight description section 1010. The consumer may select a flight to be displayed in the flight description section 1010. The flight may include a flight selected for the one or more passengers of the multi-passenger and multiattribute travel itinerary. In an example embodiment, the consumer may close the flight description section 1010 if not needed. In a further example embodiment, the flight description section 1010 may have a ‘Change Flight’ button 1015.

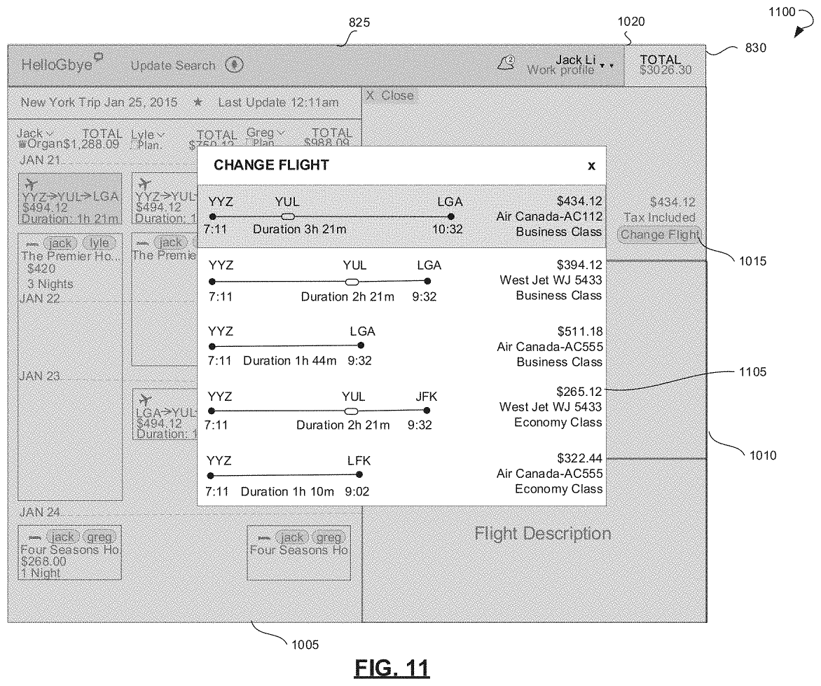

FIG. 11 is a diagram 1100 that shows a menu 1105 of the user interface 1020. The menu 1105 may be displayed after the consumer presses the ‘Change Flight’ button 1015. The menu 1105 may show a list of feasible flights selected for the passenger during the search. Upon reviewing flight information shown in the menu 1105, such as departure time, arrival time, flight duration, number of flight connections, and a flight price, the consumer may select the flight.

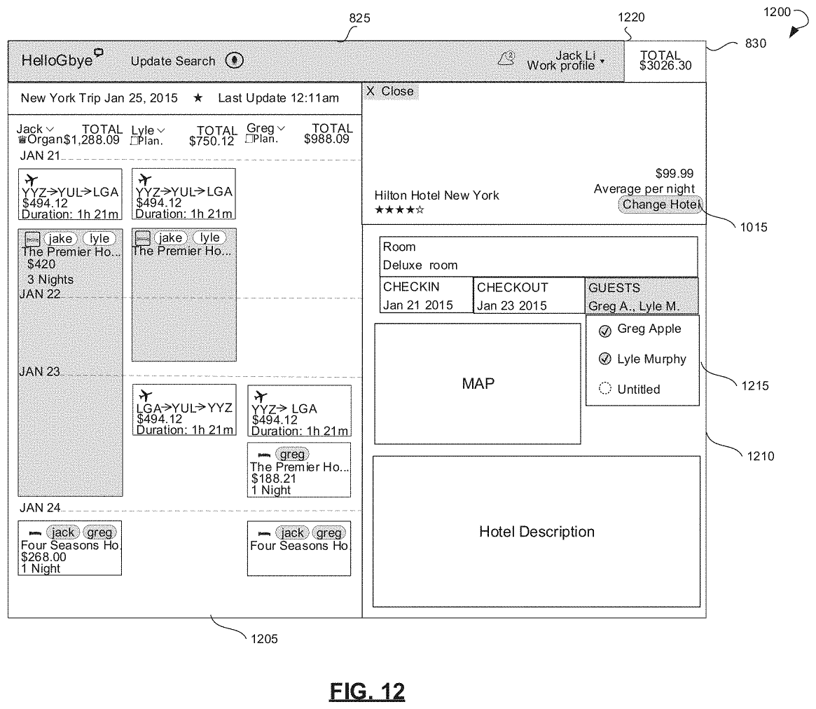

FIG. 12 is a diagram 1200 that shows a user interface 1220, according to an example embodiment. The user interface 1220 may display a matrix 1205 for displaying a multi-passenger travel and multiattribute itinerary for several passengers and a hotel description section 1210. The hotel description section 1210 may include hotel-specific information, such as a hotel rating, a check-in time, a check-out time, a map with the hotel depicted on the map, and a hotel description. Additionally, a list 1215 of passengers may be displayed to show passengers for which this hotel is selected according to the multi-passenger and multiattribute travel itinerary. In an example embodiment, the consumer may close the hotel description section 1210 if not needed.

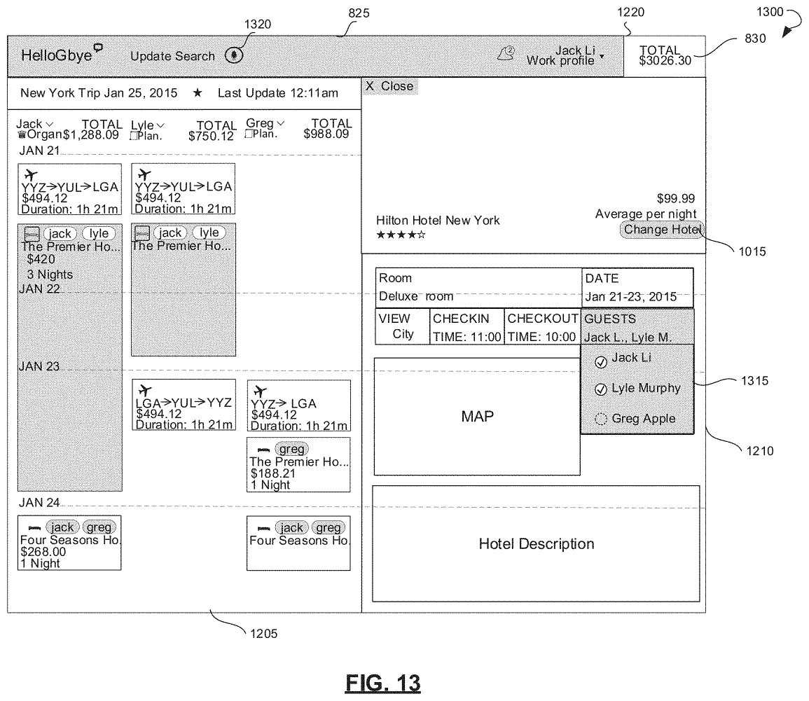

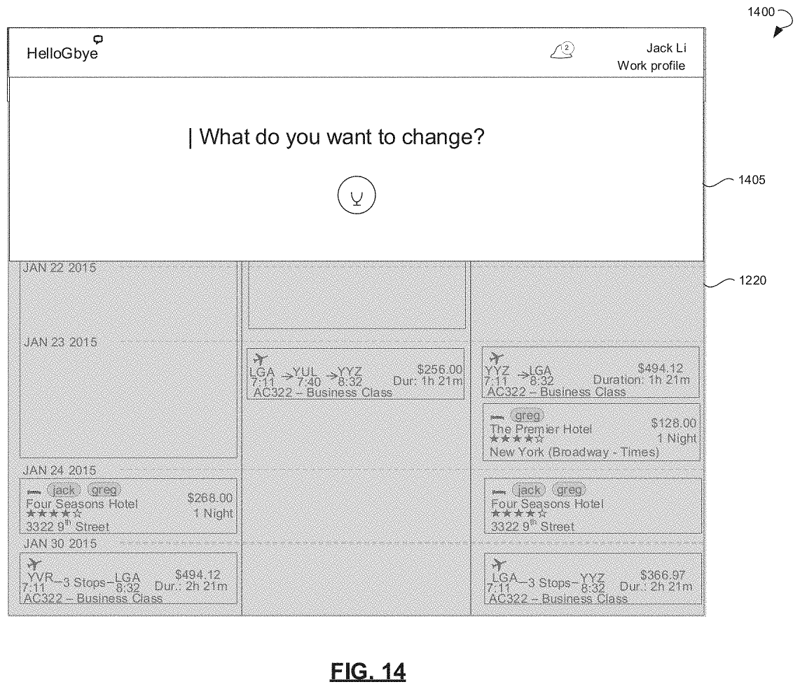

FIG. 13 is a diagram 1300 that shows a user interface 1220, according to another example embodiment. The user interface 1220 may enable the user to add one or more passengers to a list 1315 of passengers. Based on such addition, the hotel shown in the hotel description section 1210 may be also selected for the passenger added by the consumer to the list 1315 of passengers. Moreover, the user interface 1220 may have an ‘Update Search’ button 1320, described in detail with reference to FIG. 14.

FIG. 14 is a diagram 1400 that shows a user interface 1220, according to another example embodiment. Upon selecting the ‘Update Search’ button 1320 shown on FIG. 13, a section 1405 may be displayed to the consumer. The section 1405 may provide an incentive for the user to change one or more attribute values of the multi-passenger and multiattribute travel itinerary (e.g., the section 1405 may have a text “What do you want to change?” or the like. The consumer may provide a response, or a revision request, to the incentive by voice, text, or by selecting one or more attribute values shown on the user interface 1220).

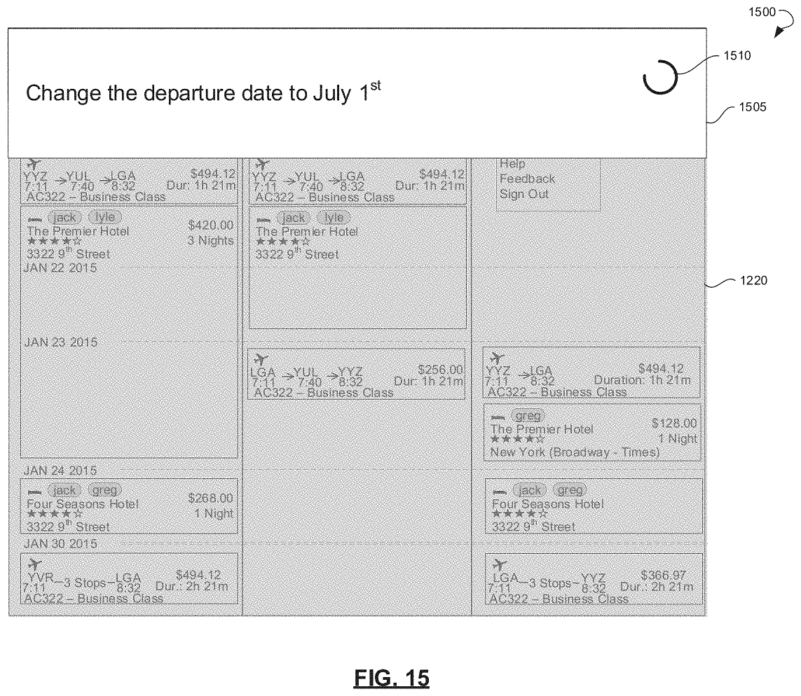

FIG. 15 is a diagram 1500 that shows a user interface 1220, according to another example embodiment. Upon receipt of the response from the consumer, the response may be parsed and displayed on the user interface 1220 in a section 1505. Therefore, the consumer may see the parsed text of the revision request and a progress of introducing changes into the multi-passenger and multiattribute travel itinerary. The progress may be represented as a pie chart 1510.

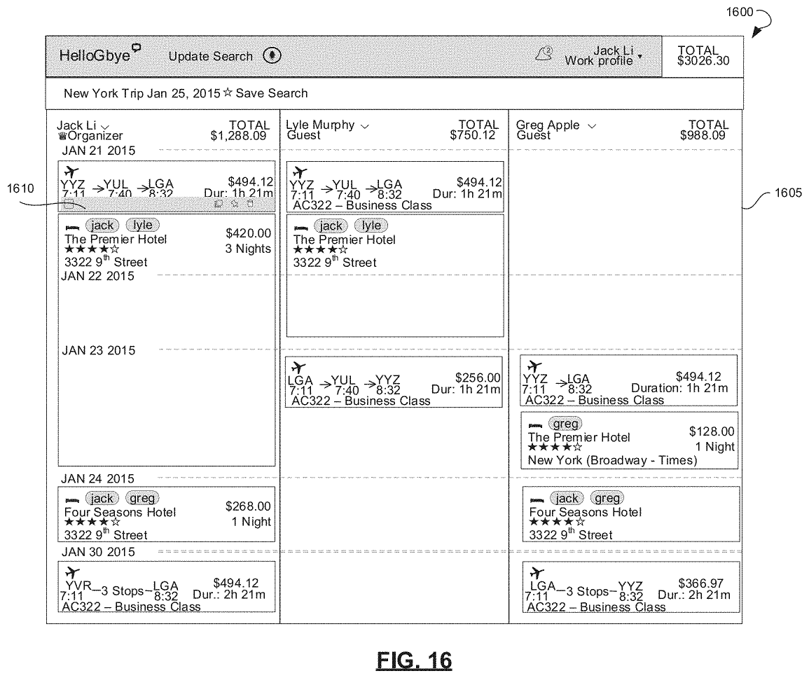

FIG. 16 is a diagram 1600 that shows a user interface 1605, according to another example embodiment. The user interface 1605 may have a panel 1610 by means of which the consumer may hide or pin some sections displayed on the user interface 1605.

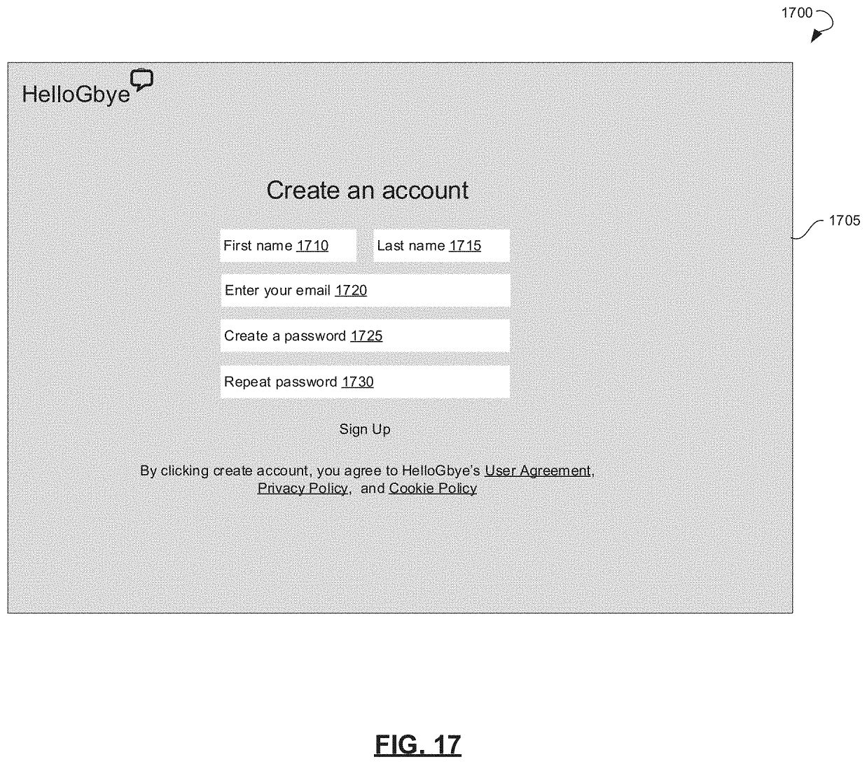

FIGS. 17-23 show example user interfaces related to a user profile in the system for facilitating multi-passenger and multiattribute travel reservations.

FIG. 17 is a diagram 1700 showing a user interface 1705 displayed to a consumer when the consumer initiates a process of registration in the system 200 for facilitating multi-passenger and multiattribute travel reservations. The consumer may need to fill-in a registration form, which may include a first name field 1710, a last name field 1715, an email field 1720, a password field 1725, a repeat password field 1730, and so forth.

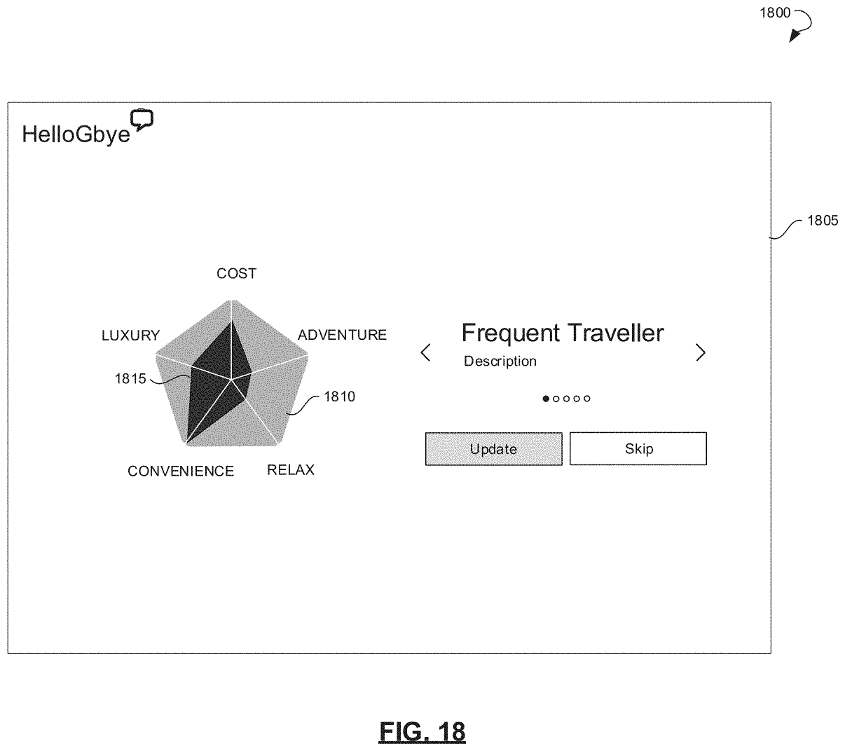

FIG. 18 is a diagram 1800 showing a user interface 1805, according to an example embodiment. The user interface 1805 may be displayed to the consumer after filling-in the registration form shown on FIG. 17. More specifically, the consumer may be requested to provide user preferences regarding multi-passenger and multiattribute travel itineraries. The system for facilitating multi-passenger and multiattribute travel reservations may have a plurality of predefined types of user profiles with predefined sets of user preferences. A vector diagram 1810 may be displayed to the consumer to show specific user preferences of a predefined type of user profile. The vector diagram 1810 may show categories of the user preferences, such as cost, adventure, relax, convenience, luxury, and the like. The consumer may set weights for each of the categories by moving corners of a polygon 1815 shown on the vector diagram 1810.

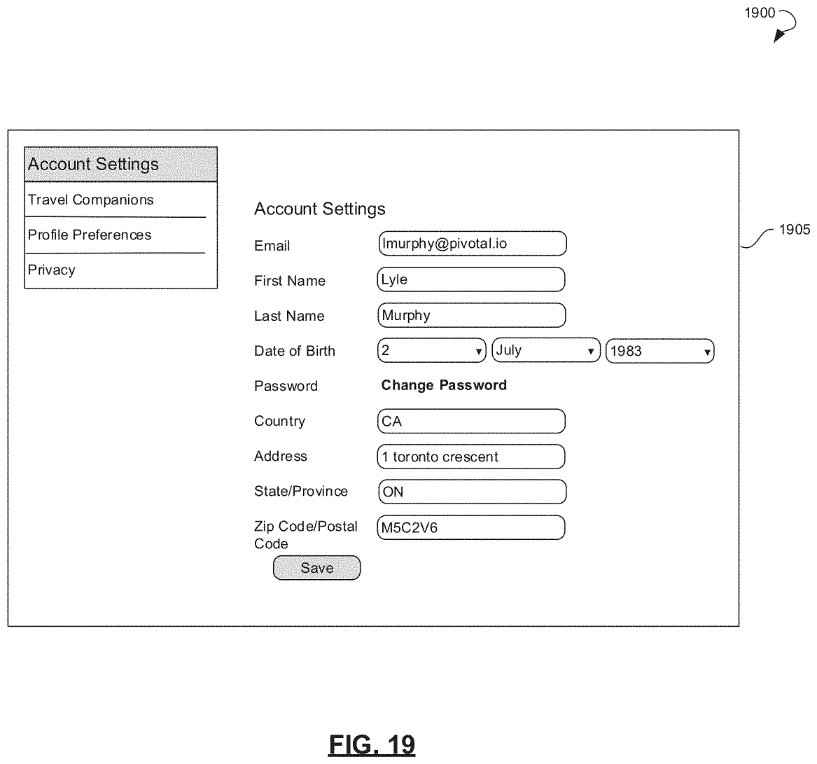

FIG. 19 is a diagram 1900 showing a user interface 1905, according to an example embodiment. The user interface 1905 may be displayed to the consumer after filling-in the registration form shown on FIG. 17. More specifically, the consumer may be requested to set account settings. The account settings may include user personal data, such as date of birth, address, and the like.

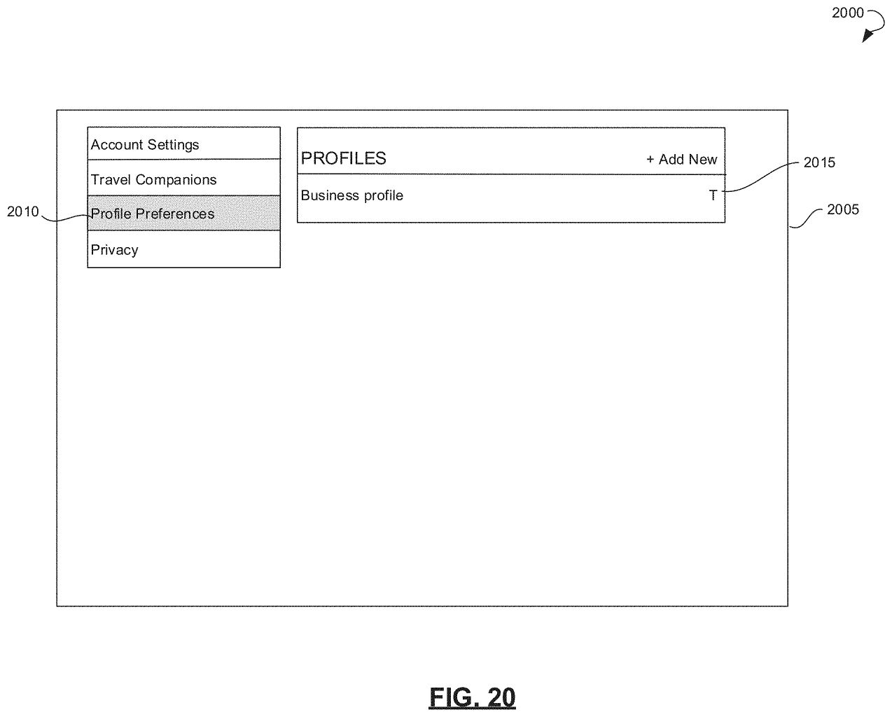

FIG. 20 is a diagram 2000 showing a user interface 2005, according to an example embodiment. The user interface 2005 may be displayed to the consumer after filling-in the registration form shown on FIG. 17. More specifically, the consumer may be requested to set profile preferences 2010, such as a type of user profile 2015. The types of user profile 2015 may include a business profile, a family profile, a leisure profile, a corporate profile, and the like. Therefore, one consumer may have several sub-profiles enabling the consumer to search for multi-passenger and multiattribute travel itineraries related to a user's work in the business profile and search for multi-passenger and multiattribute travel itineraries related to family trips of the user in the family profile.

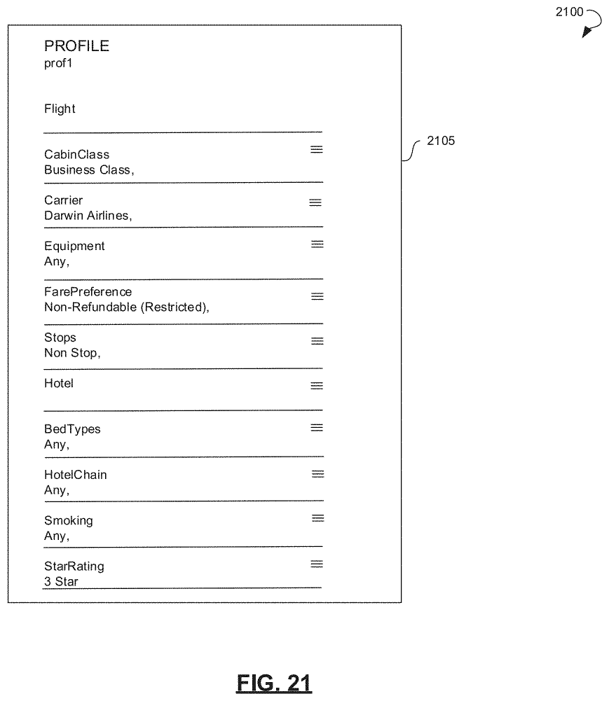

FIG. 21 is a diagram 2100 showing a user interface 2105, according to an example embodiment. The user interface 2105 may be displayed to the consumer upon selection of the type of user profile 2015 shown on FIG. 20. More specifically, the consumer may review and select profile preferences associated with the selected type of user profile.

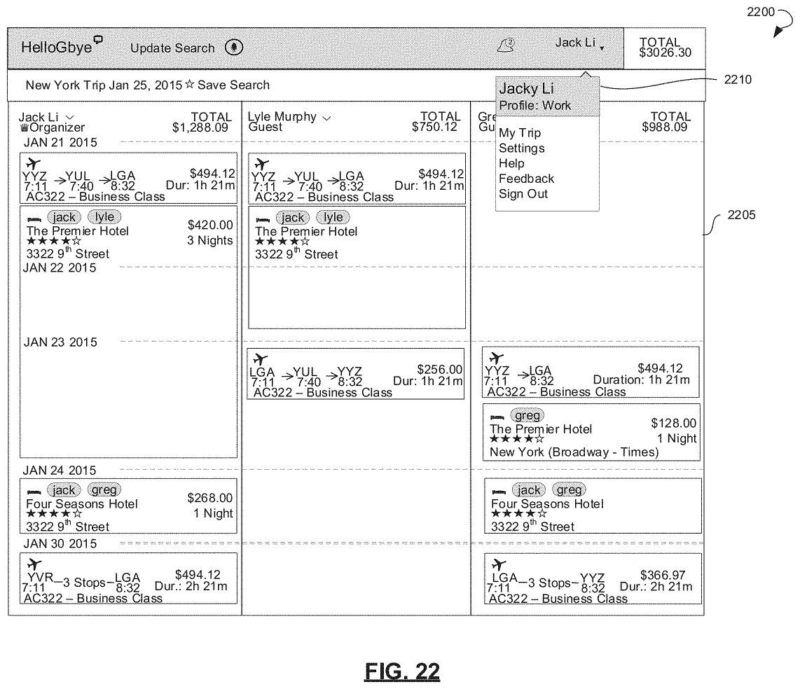

FIG. 22 is a diagram 2200 showing a user interface 2205, according to an example embodiment. After completion of the process of registration, the consumer may review or change data related to the user profile by selecting a profile menu 2210.

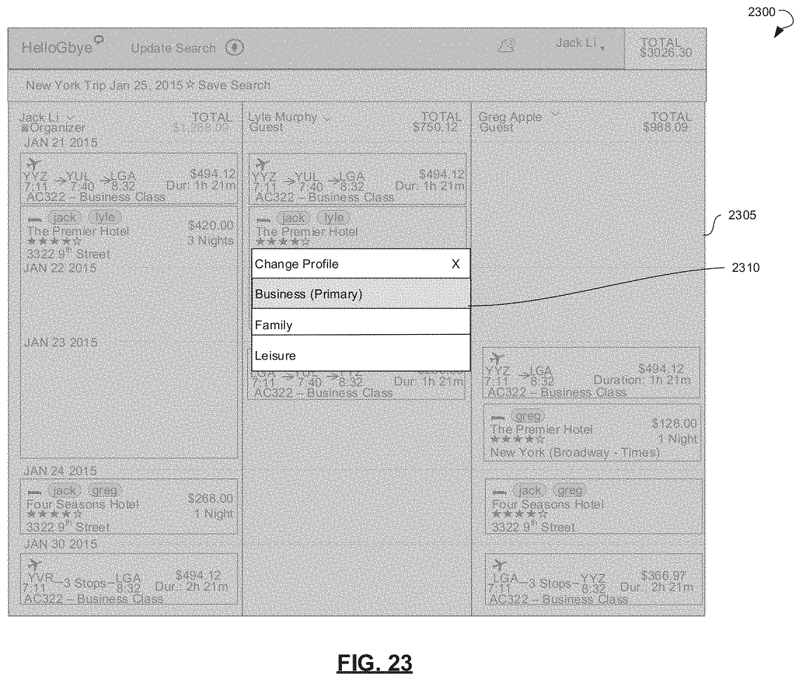

FIG. 23 is a diagram 2300 showing a user interface 2305, according to an example embodiment. The consumer may change the type of the user profile by selecting the type of user profile in a section 2310 displayed to the consumer.

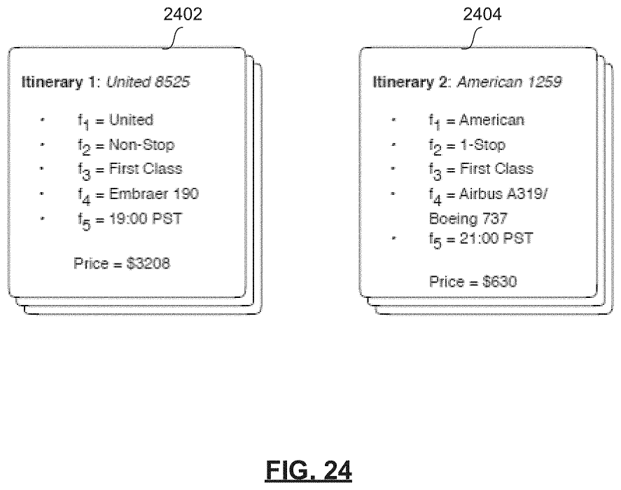

FIG. 24 shows a travel itinerary 2402 and a travel itinerary 2404 for one of the plurality of passengers. Each of the travel itinerary 2402 and the travel itinerary 2404 may have attribute values f₁, f₂, f₃, f₄, f₅.

Look-up tables stored in a database may be used to determine that the wide-body plane request is not satisfied in either of the travel itinerary 2402 and the travel itinerary 2404, and that the instantiated DAT is satisfied in the travel itinerary 2402, but not in the travel itinerary 2404.

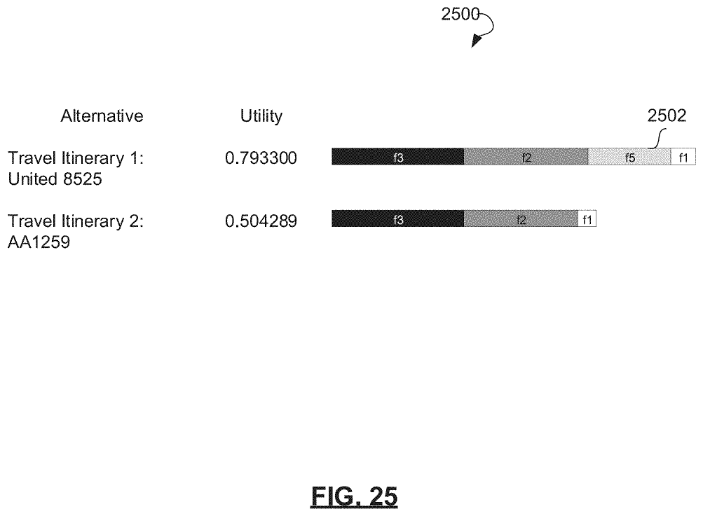

FIG. 25 shows an implementation 2500 of the relevant portion of Equation (14), which yields the set of numeric results graphically illustrated below. As shown on FIG. 25, travel itinerary 1 (corresponds to travel itinerary 2402 shown on FIG. 24) is ranked higher than travel itinerary 2 (corresponds to travel itinerary 2404 shown on FIG. 24), primarily due to the fact that travel itinerary 1 scores better on the DAT attribute 2502 (attribute f₅). Given rank-order importance (3rd) of this attribute in overall ranking of flight attributes of the traveler, together with the fact that travel itinerary 2 is a 1-stop flight, these numeric results square with a decision of the desirability of travel itinerary 1 over travel itinerary 2.

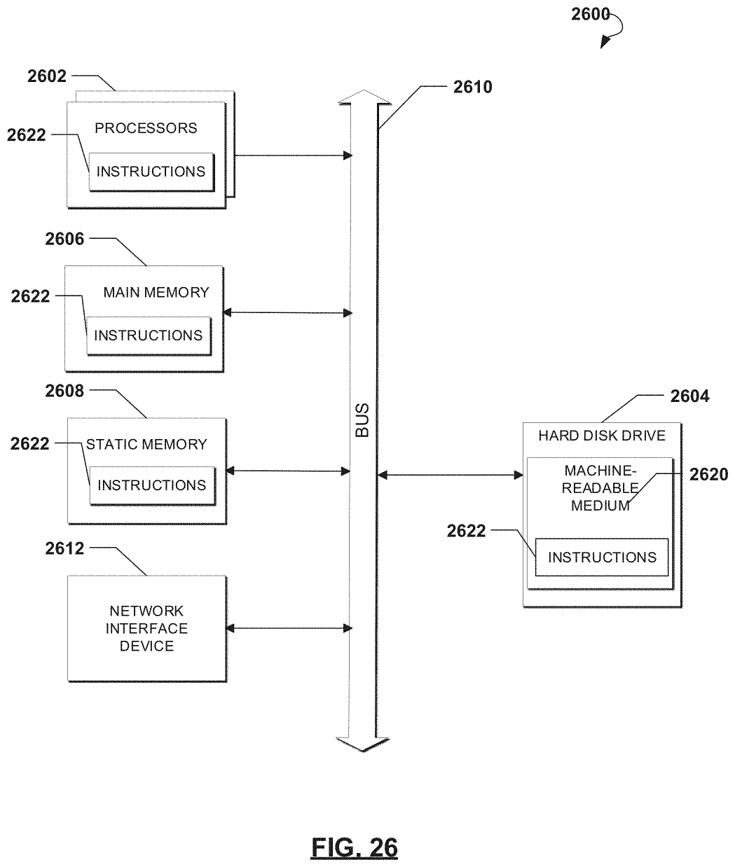

FIG. 26 shows a diagrammatic representation of a computing device for a machine in the exemplary electronic form of a computer system 2600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2600 includes a processor or multiple processors 2602, a hard disk drive 2604, a main memory 2606, and a static memory 2608, which communicate with each other via a bus 2610. The computer system 2600 may also include a network interface device 2612. The hard disk drive 2604 may include a computer-readable medium 2620, which stores one or more sets of instructions 2622 embodying or utilized by any one or more of the methodologies or functions described herein. The instructions 2622 can also reside, completely or at least partially, within the main memory 2606 and/or within the processors 2602 during execution thereof by the computer system 2600. The main memory 2606 and the processors 2602 also constitute machine-readable media.

While the computer-readable medium 2620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 2600 may be implemented as a cloud-based computing environment, such as a virtual machine operating within a computing cloud. In other embodiments, the computer system 2600 may itself include a cloud-based computing environment, where the functionalities of the computer system 2600 are executed in a distributed fashion. Thus, the computer system 2600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for facilitating travel reservations are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A system for facilitating multi-passenger and multiattribute travel reservations, the system comprising:
a database in communication with a processor, the database having stored thereon:
a travel lexicon having attribute names and related values for passengers, flights, hotels, origins, and destinations; and
a travel taxonomy comprising look-up tables having logical relations and predicates;
a scheduler in communication with the processor and operable to:
instantiate, for each of a plurality of attributes of a travel request, at least one attribute of the plurality of attributes in terms of the travel lexicon that are relevant to user preferences, thereby generating a plurality of instantiated user preferences;
index the plurality of instantiated user preferences, thereby generating an attribute index comprising a plurality of indexed travel attributes defined in terms of the travel lexicon; and
search for feasible travel itineraries based on the plurality of indexed travel attributes, the feasible travel itineraries determined based on at least two weighted attributes associated with each of the plurality of attributes;
a parser in communication with the processor and operable to:
parse the user preferences to derive a vector function comprising at least two attribute values related to the plurality of indexed travel attributes for each of the plurality of attributes; and
ascertain a plurality of relevant attribute sets for the user preferences, each of the plurality of relevant attribute sets being associated with one of the plurality of attributes, each of the plurality of relevant attribute sets comprising the at least two attribute values for the user preferences;
the processor in communication with the database, the scheduler, and the parser, the processor operable to:
receive the user preferences from the consumer via a user device, the user preferences being associated with the plurality of attributes;
rank the at least two attribute values related to the relevant attribute set based on encoded preference information derived from the user preferences, thereby generating a ranking that represents a relative importance of each attribute value related to the relevant attribute set;
assign weights to each of the at least two attribute values based on the ranking to create at least two weighted attributes for the relevant attribute set;
associate a value to each of the feasible travel itineraries based on the at least two weighted attributes and a value score corresponding to a performance of the feasible travel itinerary under each of the at least two travel attributes, thereby generating rank-order preference data for the user preferences; and
transmit the feasible travel itineraries to the user device to present, to the consumer via the user device, at least one multiattributed travel itinerary to visualize itinerary information associated with each of the plurality of attributes, wherein at least a portion of the itinerary information is variable among the plurality of attributes.

2. The system of claim 1, wherein the user preferences are determined from at least one of a travel-related query, the database, the user device, or a server.

3. The system of claim 2, further comprising a human-computer interface to receive the user preferences.

4. The system of claim 2, wherein the database further has stored thereon one or more of the following: the preexisting user preferences of the user and the preexisting user preferences of one or more further users.

5. The system of claim 1, wherein the travel preferences are provided via at least one of the following: a natural language oral exchange, a natural language typed text, and a selection of preexisting options.

6. The system of claim 1, wherein the processor is further configured to:
receive a revision request associated with at least one of the plurality of attributes, the revision request being associated with an alteration of at least one of the attribute values or an addition of a further attribute value; and
based on the revision request, instantiate a further attribute with an altered derived attribute value or the further attribute value; and
wherein the scheduler is further configured to search, based on the instantiating, for further feasible travel itineraries based on the further attribute.

7. The system of claim 1, wherein the presenting the multiattributed travel itinerary further comprises:
identifying, based on the weights, one or more attributes having highest weights; and
visually marking the one or more attributes having the highest weights on the multiattributed travel itinerary.

8. The system of claim 7, wherein the presenting further includes providing visual cues on the multiattributed travel itinerary, the visual cues being associated with the one or more attributes having the highest weights.

9. The system of claim 7, wherein the processor is further configured to select the at least one multiattributed travel itinerary from the feasible travel itineraries, wherein the at least one multiattributed travel itinerary is associated with the one or more attributes having the highest weights for at least one of the plurality of attributes.

10. The system of claim 7, wherein the presenting includes visualizing segments of the at least one multiattributed travel itinerary.

11. The system of claim 1, wherein the at least one multiattributed travel itinerary for the plurality of attributes is presented as a matrix, the matrix comprising a plurality of columns and a plurality of rows, each of the plurality of columns in the matrix associated with one of the plurality of attributes, and each of the plurality of rows in the matrix is associated with at least one attribute.

12. The system of claim 11, wherein the each of the plurality of rows is further associated with at least one of the following: hotel information, rental car information, and flight information.

13. The system of claim 1, wherein the user preferences are configured to be graphically displayed to a consumer via a vector diagram depicting categories of the user preferences, and the consumer sets weights for each of the categories by moving corners of a polygon shown on the vector diagram.

14. A method for facilitating multi-passenger and multiattribute travel reservations by a computer processor in communication with a database having stored thereon (a) a travel lexicon having attribute names and related attribute values for passengers, flights, hotels, origins, and destinations, and (b) a travel taxonomy comprising look-up tables having logical relations and predicates, the method comprising:
receiving user preferences from the consumer via a user device, the user preferences being associated with a plurality of attributes;
instantiating, for each of a plurality of attributes of a travel request, at least one travel attribute in terms of the travel lexicon that is relevant to the user preferences, thereby generating a plurality of instantiated user preferences;
indexing the plurality of instantiated user preferences, thereby generating an attribute index comprising a plurality of indexed travel attributes defined in terms of the travel lexicon;
parsing the user preferences to derive a vector function comprising at least two attribute values related to the plurality of indexed travel attributes comprised in the attribute index;
ascertaining a plurality of relevant attribute sets for the user preferences, each of the plurality of relevant attribute sets being associated with one of the plurality of attributes, wherein the plurality of relevant attribute sets comprising at least two attribute values for the user preferences;
receiving user preferences for the user from a consumer;
ranking the at least two attribute values related to the relevant attribute set based on encoded preference information derived from the user preferences, thereby generating a ranking that represents a relative importance of each attribute in the relevant attribute set;
assigning weights to each of the at least two attribute values based on the ranking to create at least two weighted attributes for the relevant attribute set;
searching, for each of the plurality of attributes, for feasible travel itineraries based on the plurality of indexed travel attributes, the feasible travel itineraries determined based on the at least two weighted attributes associated with each of the plurality of attributes;
associating a value to each of the feasible travel itineraries based on the at least two weighted attributes and a value score corresponding to a performance of the feasible itinerary under each of the at least two travel attributes, thereby generating rank-order preference data for the user preferences; and
transmitting the feasible travel itineraries to the user device to present, to the consumer via the user device, at least one multiattributed travel itinerary, the multiattributed travel itinerary comprising separate itinerary information for each of the plurality of attributes.

15. The method of claim 14, wherein the user preferences are determined from at least one of a travel-related query, the database, the user device, or a server.

16. The method of claim 15, further comprising providing a human-computer interface to receive the user preferences.

17. The method of claim 14, wherein the user preferences are provided via at least one of the following: a natural language oral exchange, a natural language typed text, and a selection of preexisting options.

18. The method of claim 15, wherein the database further has stored thereon one or more of the following: the preexisting user preferences of the user and the preexisting user preferences of one or more further users.

19. The method of claim 14, further comprising:
receiving, by the processor, a revision request, the revision request being associated with at least one of the plurality of attributes, the revision request being associated with an alteration of at least one of the attribute values or an addition of a further attribute value;
based on the revision request, instantiating, by the processor, a further attribute with an altered derived attribute value or the further attribute value; and
based on the instantiating, searching, by the scheduler, for further feasible travel itineraries based on the further attribute.

20. The method of claim 14, wherein the presenting the multiattributed travel itinerary further comprises:
identifying, based on the weights, one or more attributes having highest weights; and
visually marking the one or more attributes having the highest weights on the multiattributed travel itinerary.

21. The method of claim 20, wherein the presenting further includes providing visual cues on the multiattributed travel itinerary, the visual cues being associated with the one or more attributes having the highest weights.

22. The method of claim 20, wherein the presenting includes visualizing segments of the at least one multiattributed travel itinerary.

23. The method of claim 20, wherein the at least one multiattributed travel itinerary for each of the plurality of attributes is presented as a matrix, the matrix comprising a plurality of columns and a plurality of rows, each of the plurality of columns in the matrix associated with one of the plurality of attributes, and each of the plurality of rows in the matrix associated with at least one attribute.
